(19) United States
(12) Patent Application Publication
(10) Pub. No.: US 2026/0261928 A1
(43) Pub. Date: Sep. 3, 2026

(54) Handling a Conditional Reconfiguration Execution

(71) Applicant: Telefonaktiebolaget LM Ericsson (publ), Stockholm (SE)

(72) Inventors: Cecilia Eklöf, Täby (SE); Icaro Leonardo Da Silva, Solna (SE); Jens Bergqvist, Linköping (SE)

(21) Appl. No.: 19/155,586

(22) PCT Filed: Feb. 16, 2024
(86) PCT No.: PCT/IB2024/051497

§ 371 Date: Aug. 12, 2025

Related U.S. Application Data
(60) Provisional application No. 63/446,166, filed on Feb. 16, 2023.

(51) Int. Cl. H04W 36/00; H04W 36/36

(52) U.S. Cl. CPC H04W 36/00835; H04W 36/362

(57) ABSTRACT

The present disclosure provides a method for handling a conditional reconfiguration execution. The method is performed by a User Equipment (UE). The method comprises selecting (300) a triggered Primary Cell (PCell) and an associated triggered Primary Secondary Cell (PSCell) for the conditional reconfiguration execution in response to at least one triggered PCell and at least one associated triggered PSCell existing.

### TECHNICAL FIELD

The present disclosure relates to methods for handling a conditional reconfiguration execution and a user equipment configured to perform those methods.

### BACKGROUND

In the Third Generation Partnership Project (3GPP) Release 16 (Rel-16) Conditional Handover (CHO) was standardized. In CHO, the user equipment (UE) is configured with execution conditions and handover target configurations. The UE monitors the execution conditions and when the conditions are fulfilled, the UE applies the configuration of the target cell. The target configuration is prepared in advance, which makes the execution of the handover faster and at less risk of failures. When the UE executes the CHO or a regular handover, all (other) conditional reconfigurations are released.

FIG. 1 shows a conditional handover execution. More specifically, FIG. 1 shows a conditional Primary Secondary Cell (PSCell) Change (CPC) in 3GPP Rel-16.

With reference to FIG. 1, at step 100, the serving network node transmits User Plane (UP) data to a UE. At step 102, the UE transmits a measurement report to the serving network node. At step 104, the serving network node takes a handover decision based on the report. At step 106, the serving network node transmits an early handover request to a target network node. At step 108, the target network node accepts the handover and builds a Radio Resource Control (RRC) configuration. At step 110, the target network node transmits a handover acknowledgement to the serving network node. At step 112, the serving network node transmits a conditional handover command to the UE. At step 114, in response to measurements fulfilling a handover condition, the UE triggers the pending conditional handover. At step 116, the UE transmits a synchronization and random access request to the target network node. At step 118, the UE transmits a handover confirmation to the target network node. At step 120, the target network node transmits a handover complete message to the serving network node. At step 122, the target network node transmits UP data to the UE.

A solution for Conditional PSCell Change (CPC) procedure was also standardized in Rel-16. Therein, a UE operating in Multi-Radio Dual Connectivity (MR-DC) receives, in a conditional reconfiguration, one or multiple Radio Resource Control (RRC) Reconfiguration(s) (e.g. an RRCReconfiguration message) containing a Secondary Cell Group (SCG) configuration (e.g. a secondaryCellGroup of Information Element (IE) CellGroupConfig) with a reconfigurationWithSync that is stored and associated to an execution condition (e.g. a condition like an A3/A5 event configuration), so that one of the stored messages is only applied upon the fulfillment of the execution condition, e.g. associated with the serving PSCell, upon which the UE performs a PSCell change (in case it finds a neighbour cell that is better than the current PSCell of the SCG). Only intra-Secondary Node (SN) CPC without Master Node (MN) involvement is standardized in 3GPP Rel-16, i.e. for cases where the (candidate) target PSCells are located in the current serving SN.

Similar to conditional handover, in case a random access was performed for a target PSCell and the UE was configured with CPC, the UE then releases all the conditional reconfigurations that it has stored.

In 3GPP Release 17 (Rel-17) solutions for Conditional PSCell Addition (CPA) and inter-SN CPC are being discussed and introduced. The CPA procedure is used for adding a PSCell/SCG to the configuration for a UE that is currently only configured with a Master Cell Group (MCG), when associated execution conditions are fulfilled. CPA is initiated by the MN by requesting an SCG configuration, which is to be provided as part of a conditional reconfiguration to the UE, from a (candidate) target SN (T-SN), and then sending it in a conditional reconfiguration to the UE together with the associated execution conditions.

Inter-SN CPC can be initiated either by the MN or by the source SN (S-SN), where the signaling towards the source SN and the (candidate) target SNs, as well as towards the UE, in both cases is handled by the MN.

There is a possibility of CHO with a secondary node. In 3GPP Rel-17, the possibility to configure CHO with a target configuration containing an SCG was introduced. This is described in 3GPP Technical Specification (TS) 37.340 Version (v) 17.3.0, chapter 10.19 or, more specifically, chapter 10.19.2 entitled “MR-DC with 5GC (fifth generation core)”. The Conditional Handover with Secondary Node procedure is used for configuration and execution of CHO with SN. This procedure includes the cases where the SN is kept, changed or added. If the SN is kept, the UE context at the SN is kept. If the SN is changed, the UE context at the source SN is moved to the target SN.

FIG. 2 shows a conditional handover with secondary node procedure. FIG. 2 corresponds to FIG. 10.19.2-1 of 3GPP TS 37.340 v 17.3.0.

With reference to FIG. 2, at step 200, a source MN transmits a handover request to a first target MN. At step 202, the source MN transmits a handover request to a second target MN. At step 204, the first target MN transits an SN addition request to a first target SN. At step 206, the first target MN transmits an SN addition request to a second target SN. At step 208, the second target MN transmits the SN addition request to the second target SN. At step 210, the first target SN transmits an SN addition request acknowledgement to the first target MN. At step 212, the second target SN transmits an SN addition request acknowledgement to the first target MN. At step 214, the second target SN transmits an SN addition request acknowledgement to the second target MN. At step 216, the first target MN transmits an Xn-U address indication to the first target SN. At step 218, the first target MN transmits an Xn-U address indication to the second target SN. At step 220, the second target MN transmits an Xn-U address indication to the second target SN.

At step 222, the first target MN transmits a handover request acknowledgement to the source MN. At step 224, the second target MN transmits a handover request acknowledgement to the source MN. At step 226, the source MN transmits an RRC configuration to the UE. The RRC configuration may comprise an MN RRC reconfiguration and may comprise an SN RRC reconfiguration. At step 228, the UE transmits an RRC reconfiguration complete message to the source MN. At step 230, early data forwarding is performed. At step 232, a random access procedure is performed between the UE and the first target MN. At step 234, the UE transmits an RRC reconfiguration complete message to the first target MN. The RRC reconfiguration complete message may comprise an SN RRC reconfiguration complete indication. At step 236, a random access procedure is performed between the UE and the first target SN. At step 238, the first target MN transmits an SN reconfiguration complete message to the first target SN.

At step 240, the first target MN transmits a handover success message to the source MN. At step 242, the source MN transmits an SN release request to the source SN. At step 244, the source SN transmits an SN release request acknowledgement to the source MN. At step 246, the source MN transmits an Xn-U address indication to the source SN. At step 248, the source MN transmits a handover cancel message to the second target MN. At step 250, the first target MN transmits an SN release request to the second target SN. At step 252, the second target MN transmits an SN release request to the second target SN. At step 254, the second target SN transmits an SN release request acknowledgment to the first target MN. At step 256, the second target SN transmits an SN release request acknowledgment to the second target MN.

At step 258, the source SN transmits a secondary Radio Access Technology (RAT) data usage report to the source MN. At step 260, the source MN transmits the RAT data usage report to an Access and Mobility Management Function (AMF). At step 262, the source SN transmits an SN status transfer to the source MN. At step 264, the source MN transmits the SN status transfer to the first target MN. At step 266, the first target MN transmits the SN status transfer to the first target SN.

At step 268, a User Plane Function (UPF) performs data forwarding to the source MN. At step 270, the source MN performs data forward to the first target MN. At step 272, the first target MN transmits a path switch request to the AMF. At step 274, the AMF performs bearer modification with the UPF. At step 276, the UPF transmits a new path (MN terminated bearer) to the first target MN. At step 278, the UPF transmits a new path (SN terminated bearer) to the first target SN. At step 280, the AMF transmits a path switch request acknowledgement to the first target MN. At step 282, the first target MN transmits a UE context release message to the source MN. At step 284, the source MN transmits the UE context release message to the first source SN.

There is a possibility of CHO with a candidate SCG. As shown above, in Rel-17, the configuration of a target candidate cell (e.g. condRRCReconfig of IE OCTET STRING (CONTAINING RRCReconfiguration), within a CHO configuration (e.g. the IE ConditionalReconfiguration, as defined in 3GPP TS 38.331 v17.3.0), may include an SCG configuration, to be applied by the UE when the execution condition for CHO is fulfilled. The network configures a specific PSCell for a target candidate cell configuration and the UE applies the configuration for the PSCell (and possibly associated SCG Secondary Cell(s) (SCell(s))) when the CHO condition(s) are fulfilled. In Rel-17 there are no execution conditions related to the PSCell.

In the Release 18 (Rel-18) work item for mobility enhancements, one objective is to configure CHO with candidate SCG wherein the UE receives, in addition to the CHO execution condition(s) related to the MCG (e.g. CHO candidate cell an offset better than the Primary Cell (PCell)), execution condition(s) related to the SCG (in addition to the CHO execution condition(s)).

The following agreements have been made in RAN2 related to this objective:

### In RAN2 #119:

Observation: Current RAN2 Stage-3 specifications can support CHO including target MCG and target SCG in Rel-17.

CHO configuration referring to or including CPC or CPA (CPC/CPA) configuration (intended to be applicable together) can be supported.

For further study (FFS): When triggering CHO, the UE performs CPC/CPA configuration to start CPC/CPA evaluation, if CHO evaluation and CPC/CPA evaluation is concurrent or sequential.

### In RAN2 #120:

Execution order: the UE does not execute CPC/CPA unless the CHO condition is fulfilled (regardless of parallel or sequential evaluation) There currently exist certain challenges.

### SUMMARY

3GPP is discussing whether the evaluation of the execution conditions and execution of CHO and CPC performed by the UE is concurrent (e.g. performed in parallel) or sequential, in the case where a CHO configuration for a target candidate contains or is associated to the configuration of a candidate SCG.

Up to Rel-17, when only CHO is configured, the UE performs CHO execution when a CHO target candidate fulfills the CHO execution condition. Also, when multiple candidates fulfill their condition, the UE selects one of them. The existing text in the RRC specifications is shown below:

Specifically, 3GPP TS 38.331 v17.3.0, Section 5.3.5.13.4, Conditional reconfiguration evaluation, states the following:

| 1> | for each condReconfigId (conditional reconfiguration identifier) within the | |
|---|---|---|
| | VarConditionalReconfig: | |
| | | [...] |
| | 2> | for each measId (measurement identifier) included in the measIdList within |

| VarMeasConfig indicated in the condExecutionCond or condExecutionCondSCG | |
|---|---|
| associated to condReconfigId: | |
| [...] | |
| 3> | if the condEventId is associated with condEventA3, condEventA4 or |

condEventA5, and if the entry condition(s) applicable for this event associated
with the condReconfigId, i.e. the event corresponding with the condEventId(s) of
the corresponding condTriggerConfig within VarConditionalReconfig, is fulfilled
for the applicable cells for all measurements after layer 3 filtering taken during
the corresponding timeToTrigger defined for this event within the
VarConditionalReconfig:
4>consider the event associated to that measId to be fulfilled;
[...]

| | |
|---|---|
| 2> | if event(s) associated to all measId(s) within condTriggerConfig for a target |

| candidate cell within the stored condRRCReconfig are fulfilled: | |
|---|---|
| 3> | consider the target candidate cell within the stored condRRCReconfig, associated |
| | to that condReconfigId, as a triggered cell; |
| 3> | initiate the conditional reconfiguration execution, as specified in 5.3.5.13.5; |

[...]

However, with the introduction in Rel-18 of CHO with an associated candidate SCG (e.g. CPC configuration within a CHO target candidate configuration), and with the associated candidate SCG also having an execution condition (denoted CPC execution condition), it is not clear how the UE performs the CHO execution procedure, as multiple execution conditions, associated to the same CHO target candidate cell exist. In addition, it is not clear how the UE selects the configuration to apply during CHO execution, in the case where there are multiple SCG candidate cells for a given CHO target candidate cell.

Another issue is that it is not clear how the UE selects the target candidate cells for CHO (candidate PCell) and for CPC/CPA (candidate PSCell), especially in the case that a target candidate MN (denoted T-MN), when requested to configure CHO, configures a candidate PCell with a CHO execution condition, and multiple associated candidate PSCell(s), or SCG(s), with associated CPC/CPA execution condition.

Certain aspects of the disclosure and their embodiments may provide solutions to the above-described or other challenges.

Accordingly, in one aspect, there is provided a method for handling a conditional reconfiguration execution. The method is performed by a User Equipment (UE). The method comprises selecting a triggered Primary Cell (PCell) and an associated triggered Primary Secondary Cell (PSCell) for the conditional reconfiguration execution in response to at least one triggered PCell and at least one associated triggered PSCell existing.

In another aspect, there is provided a UE for handling a conditional reconfiguration execution. The UE comprises processing circuitry configured to cause the UE to select a triggered PCell and an associated triggered PSCell for the conditional reconfiguration execution in response to at least one triggered PCell and at least one associated triggered PSCell existing.

In another aspect, there is provided a computer program comprising instructions which, when executed by processing circuitry of a UE, cause the UE to perform the method described earlier.

In another aspect, there is provided a computer program product, embodied on a non-transitory machine-readable medium, comprising instructions which are executable by processing circuitry of a UE to cause the UE to perform the method describer earlier.

### BRIEF DESCRIPTION OF THE DRAWINGS

For a better understanding of the techniques, and to show how they may be put into effect, reference will now be made, by way of example, to the accompanying drawings, in which:

FIG. 1 illustrates an example conditional handover procedure;

FIG. 2 illustrates another example conditional handover procedure;

FIG. 3 a block diagram illustrating a method according to an embodiment;

FIG. 4 illustrates an example configuration of conditional reconfigurations;

FIG. 5 illustrates a first signaling option according to an embodiment;

FIG. 6 illustrates some information elements according to an embodiment;

FIG. 7 illustrates a second signaling option according to an embodiment;

FIG. 8 is a block diagram illustrating a system according to an embodiment;

FIG. 9 is a block diagram illustrating a user equipment according to an embodiment;

FIG. 10 is a block diagram illustrating a network node according to an embodiment;

FIG. 11 is a block diagram illustrating a host computer according to an embodiment;

FIG. 12 is a block diagram illustrating a virtualization environment according to an embodiment; and

FIG. 13 is a block diagram illustrating a host computer communicating via a network node with a user equipment according to an embodiment.

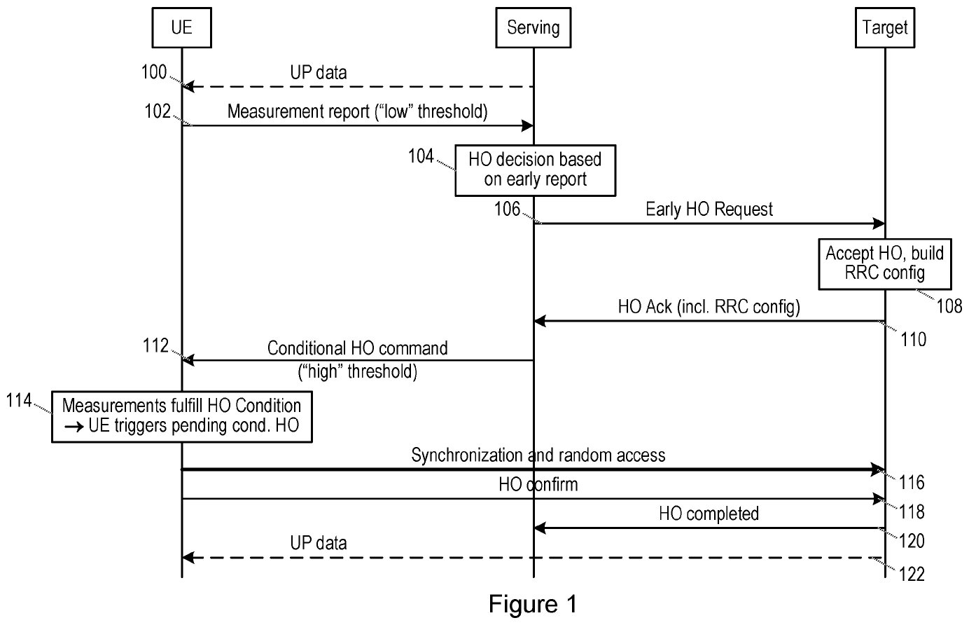

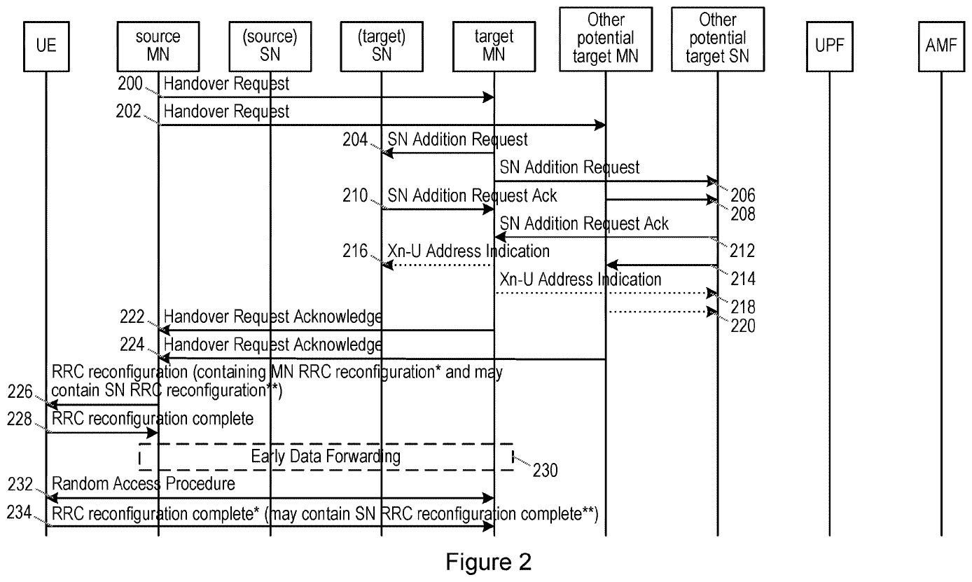

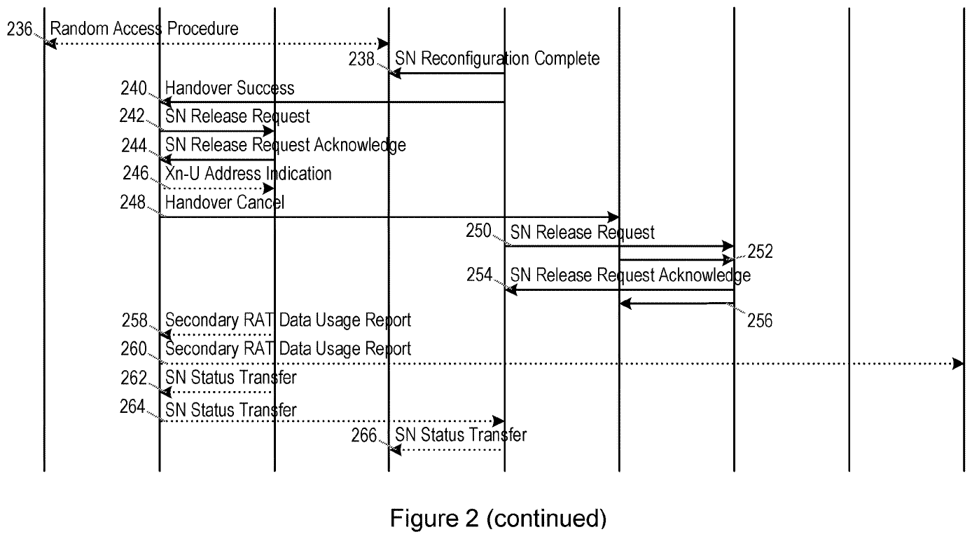

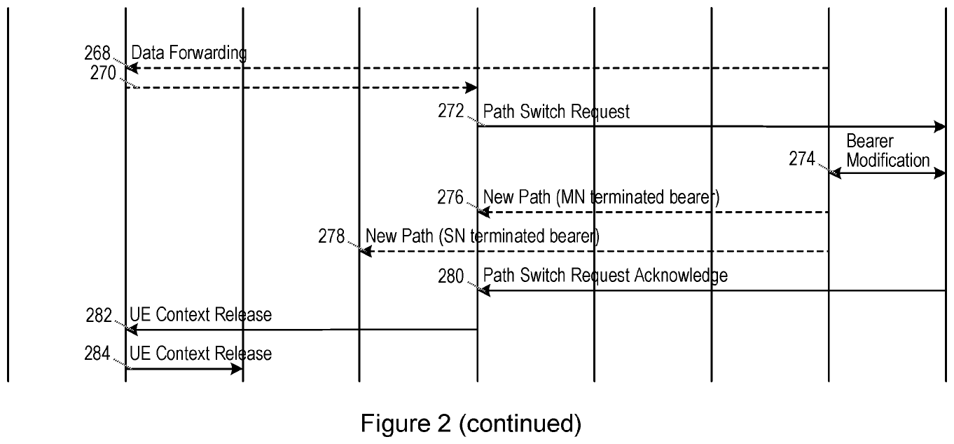

### DETAILED DESCRIPTION

Some of the embodiments contemplated herein will now be described more fully with reference to the accompanying drawings. Embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

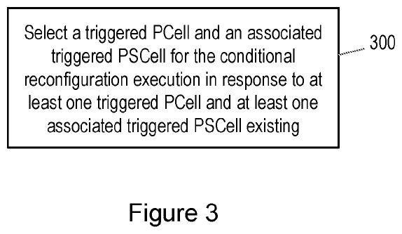

FIG. 3 illustrates a first method according to an aspect of the disclosure. The first method is for handling a conditional reconfiguration execution. The first method is performed by a User Equipment (UE). As illustrated by block 300 of FIG. 3, the first method comprises selecting a triggered Primary Cell (PCell) and an associated triggered Primary Secondary Cell (PSCell) for the conditional reconfiguration execution in response to at least one triggered PCell and at least one associated triggered PSCell existing.

The associated triggered PSCell is a triggered PSCell that is associated to (or associated with) the triggered PCell. Similarly, the at least one associated triggered PSCell is at least one triggered PSCell that is associated to (or associated with) the at least one triggered PCell. In some embodiments, the at least one triggered PCell can be at least one (candidate) PCell that is associated to the conditional reconfiguration.

Herein, at least one triggered PCell and at least one associated triggered PSCell may exist where at least one (candidate) PCell and at least one associated (candidate) PSCell (e.g. a plurality of (candidate) PCells and associated (candidate) PSCells) comprise at least one triggered PCell and at least one associated triggered PSCell. For example, this can be where a cell group comprises at least one triggered PCell and at least one associated triggered PSCell. The term “existing” can, for example, mean being present or available.

In some embodiments, the selecting may comprise selecting one of a plurality of triggered PCells and an associated triggered PSCell for the conditional reconfiguration execution in response to the plurality of triggered PCells and an associated plurality of triggered PSCells existing.

In some embodiments, the selecting may comprise selecting one triggered PCell and an associated triggered PSCell for the conditional reconfiguration execution in response to only that one triggered PCell and associated triggered PSCell existing.

In some embodiments, the selecting may be based on an implementation for the JE.

In some embodiments, the implementation for the UE may comprise one or both of beams for use by the UE and a beam quality for the UE.

In some embodiments, the selecting may comprise selecting the triggered PCell before the associated triggered PSCell.

In some embodiments, a PCell configuration may be stored for the selected triggered PCell and the first method may comprise applying the PCell configuration.

In some embodiments, the PCell configuration may be a Radio Resource Control (RRC) configuration.

In some embodiments, a PSCell configuration may be stored for the selected triggered PSCell and the first method may comprise applying the PSCell configuration.

In some embodiments, the PSCell configuration may be a Radio Resource Control (RRC) configuration (e.g. condRRCReconfig).

In some embodiments, the first method may comprise receiving a message comprising first information indicative of (e.g. identifying) at least one candidate PCell and at least one associated candidate PSCell and the selecting may comprise selecting the triggered PCell and the associated triggered PSCell for the conditional reconfiguration execution in response to the at least one candidate PCell comprising at least one triggered PCell and the at least one associated candidate PSCell comprising at least one associated triggered PSCell. Thus, in some embodiments, the UE may be aware of at least one triggered PCell and at least one associated triggered PSCell existing by receipt of the message comprising the first information. For example, the first information can indicate to the UE that at least one candidate PCell and at least one associated candidate PSCell exists.

In some embodiments, the message may be a Radio Resource Control (RRC) reconfiguration message.

In some embodiments, the message may comprise second information indicative of (e.g. identifying) a PCell configuration for the at least one candidate PCell.

In some embodiments, the message may comprise third information indicative of (e.g. identifying) a PSCell configuration for the at least one candidate PSCell.

In some embodiments, the PCell configuration may comprise a Conditional PSCell Change (CPC) configuration and the CPC configuration may comprise the third information. In some embodiments, an Information Element (IE) of the message may comprise the second information and the third information.

In some embodiments, the message may comprise fourth information indicative of (e.g. identifying) a PCell execution condition for the at least one candidate PCell and the first method may comprise evaluating whether the PCell execution condition is fulfilled for the at least one candidate PCell.

In some embodiments, the at least one candidate PCell may comprise a plurality of candidate PCells, the fourth information may be indicative of (e.g. identifying) a PCell execution condition for each of the plurality of candidate PCells, and evaluating whether the PCell execution condition is fulfilled may comprise evaluating whether the PCell execution condition is fulfilled for each of the plurality of candidate PCells.

In some embodiments, the message may comprise fifth information indicative of (e.g. identifying) a PSCell execution condition for the at least one candidate PSCell and the first method may comprise evaluating whether the PSCell execution condition is fulfilled for the at least one candidate PSCell.

In some embodiments, the at least one candidate PSCell may comprise a plurality of candidate PSCells, the fifth information may be indicative of (e.g. identifying) a PSCell execution condition for each of the plurality of candidate PSCells, and evaluating whether the PSCell execution condition is fulfilled may comprise evaluating whether the PSCell execution condition is fulfilled for each of the plurality of candidate PSCells.

In some embodiments, the at least one triggered PCell may be at least one candidate PCell for which a PCell execution condition is fulfilled. In some embodiments, the at least one associated triggered PSCell may be at least one associated candidate PSCell for which a PSCell execution condition is fulfilled.

In some embodiments, the first method may comprise performing the conditional reconfiguration execution for the selected triggered PCell and associated triggered PSCell.

In some embodiments, the conditional reconfiguration execution may be a conditional handover (CHO) execution.

There is also provided a second method for handling a conditional reconfiguration execution. The second method is performed by a UE. The second method comprises selecting a triggered PCell and an associated triggered Secondary Cell Group (SCG) cell for the conditional reconfiguration execution in response to at least one triggered PCell and at least one associated triggered SCG cell existing. The features described above in relation to embodiments of the first method can also apply to the second method, except that any references to “PSCell” in relation to embodiments of the first method are replaced with references to “SCG cell” for embodiments of the second method.

There is also provided a UE for handling a conditional reconfiguration execution. The UE comprises processing circuitry configured to cause the UE to perform the first method described earlier and/or the second method described earlier.

There is also provided a computer program comprising instructions which, when executed by processing circuitry of a UE, cause the UE to perform the first method described earlier and/or the second method described earlier.

There is also provided a computer program product, embodied on a non-transitory machine-readable medium, comprising instructions which are executable by processing circuitry of a UE to cause the UE to perform the first method described earlier and/or the second method described earlier.

The present disclosure includes sets of embodiments for methods for a UE for performing a conditional reconfiguration execution (e.g. CHO execution). The UE may receive a message (e.g. RRCReconfiguration), which can include i) a CHO target candidate cell (e.g. with one or both of a CHO execution condition and a CHO target candidate cell configuration) and ii) at least one candidate PSCell (e.g. with one or both of an associated CPC/CPA execution condition and a PSCell target candidate configuration). The candidate PSCell is associated with the CHO target candidate cell (different signaling examples of the association are disclosed).

The method may comprise the UE receiving a message (e.g. RRCReconfiguration), which can include multiple CHO target candidate cells. Each CHO target candidate cells may have one or both of a CHO execution condition and CHO target candidate cell configuration. For each CHO target candidate cell, there may be one or more PSCells associated, e.g. with each PScell having its CPC/CPA execution condition and PSCell target candidate configuration.

The method may comprise the UE receiving the message (RRCReconfiguration). The method may comprise evaluating at least the CHO execution condition(s), for one or more CHO target candidate cells. The method may comprise, when at least the CHO execution condition(s) is fulfilled, the UE performing conditional reconfiguration execution (CHO execution). The UE may perform the conditional reconfiguration execution based on one or more CHO target candidate cell(s) for which the CHO execution condition is fulfilled (denoted here CHO triggered cells) and optionally also one or more of:
i) at least one candidate PSCell associated with a CHO target candidate cell;
ii) the associated CPC/CPA execution condition i.e. the execution condition associated to the at least one candidate PSCell associated with a CHO target candidate cell; and
iii) the PSCell target candidate configuration.

In one example, the UE may receive an RRC Reconfiguration message, which may include a configuration (e.g. conditionalReconfiguration of IE ConditionalReconfiguration, as defined in 3GPP TS 38.331 v17.3.0). The configuration may include at least one CHO target candidate configuration (e.g. condRRCReconfig of OCTET STRING (CONTAINING RRCReconfiguration)). Each CHO target candidate cell may have at least one associated PSCell target candidate cell, e.g. with an associated PSCell target candidate cell configuration. In response to the received message, the UE may evaluate the CHO execution condition(s) and, when a CHO execution condition is fulfilled for at least one of the CHO target candidate cell, the UE may select a CHO target candidate cell for execution CHO (e.g. when multiple CHO target candidate cells fulfill the CHO execution condition(s)). For the selected CHO target candidate cell, the UE may perform one or more of the following actions:

when at least one PSCell target candidate cell(s) fulfills their associated CPC/CPA execution conditions:
When at least one PSCell target candidate cell(s) fulfills their associated CPC/CPA execution conditions:
   When multiple PSCell target candidate cell(s) fulfill their associated CPC/CPA execution conditions (denoted triggered PSCell candidate cells):
      The UE may further select one of the triggered PSCell target candidate cell(s) to be the selected PSCell for CHO execution (i.e. one of the PSCells associated to the selected CHO target candidate cell for which the CPC execution condition(s) has been fulfilled);
   When a single PSCell target candidate cell(s) fulfills the associated CPC execution conditions (denoted multiple triggered PSCell candidate cells):
      The UE may consider that cell the selected PSCell for CHO execution;
   Optionally, perform CHO execution for the selected CHO target candidate cell and the selected PSCell for CHO execution;
When no PSCell target candidate cell(s) fulfills the associated CPC execution conditions (denoted multiple triggered PSCell candidate cells):
   The UE may perform CHO execution only for the CHO target candidate cell i.e. without applying a PSCell target candidate cell configuration; OR
   The UE may perform CHO execution for the CHO target candidate cell, apply a CPC configuration (e.g. conditionalReconfiguration of IE ConditionalReconfiguration) within the CHO target candidate cell configuration and evaluate the CPC/CPA
The UE may apply the CHO target candidate cell configuration associated to the selected CHO target candidate cell and, when the UE selects an associated PSCell candidate cell for CHO execution, the UE may apply the associated PSCell target candidate configuration associated to the selected PSCell.

Certain embodiments may provide one or more of the following technical advantages. For example, one advantage of the proposed solution is that it provides the UE behavior during the CHO execution (e.g. upon fulfillment of the CHO execution condition) for the case the UE has a CHO target candidate cell associated to the target PSCell candidate cells, and, selecting one or more configuration(s) to be applied e.g. the CHO target candidate cell configuration and a PSCell configuration, for the selected CHO target candidate cell and its associated PSCell target candidate cell. Various embodiments are disclosed, and some embodiments will provide this and other technical advantages, as will be apparent from the present disclosure.

Some of the embodiments contemplated herein will now be described more fully with reference to the accompanying drawings. Embodiments are provided by way of example to convey the scope of the subject-matter to those skilled in the art. Additional information may also be found in the document R2-2301341, a draft version of which is provided in the Appendix.

In the present disclosure, the term “PSCell target candidate cell” is to be interpreted in the same manner as terms like PSCell candidate, candidate PSCell, PSCell candidate cell, target PSCell candidate, etc. Thus, these terms can be used interchangeably. The PSCell target candidate cell can refer to a cell which is meant to operate as a PSCell when the UE executes a conditional reconfiguration (e.g. CHO) for a conditional reconfiguration (e.g. CHO) target candidate cell which has an associated PSCell target candidate. The term “SCG candidate” or candidate SCG may also be used for a similar meaning. An SCG can contain a PSCell and may also contain further secondary serving cells for the candidate SCG.

Existing technology does not address the handling of the associated CPA/CPC configurations (and/or associated PSCell target candidate cells including an SCG configuration) to be possibly applied upon execution when the CHO execution condition is fulfilled, but execution condition for none of the associated CPA/CPC configurations is fulfilled. It may often be so that, even if the UE is in coverage of both the candidate target PCell and at least one of the target candidate PSCells, the CHO execution condition is determined fulfilled before the execution condition for the associated CPC/CPA is determined fulfilled. This can e.g. be due to the fact that the measurements related to the CHO execution condition are finalized before the measurements related to the CPC/CPA execution condition.

The disclosure details UE actions at execution of CHO with associated CPC/CPA. An option to provide, to the UE, CPC/CPA configurations that are associated to the CHO configuration consists of that the CPC/CPA configurations are included within the CHO target candidate cell configuration and that the UE evaluates the execution conditions for those CPC/CPA configurations in parallel with the execution condition for the associated CHO configuration. It is then however not clear how to handle those CPA/CPC configurations in case the execution condition for one of them is fulfilled and the corresponding CPC/CPA configuration is applied or executed together with that the CHO configuration is applied (or executed). Further details are provided.

In the context of the disclosure, an associated CPC/CPA execution condition may correspond to at least a condition which the UE evaluates (e.g. an event A3/A5/A4 based on one or more measurement identifiers) when configured with a CHO target candidate cell with an associated target candidate PSCell.

The disclosed solutions are applicable for the case that a UE is configured with at least one CHO target candidate cell with at least one associated candidate PSCell. The UE may evaluate the fulfillment of CHO execution condition(s) (e.g. one or more measurement identifier(s) (measId(s)) and associated measurement configuration for these measId(s)), and CPC/CPA execution condition(s) (e.g. one or more measId(s) and associated measurement configuration for these measId(s)), wherein a PScell target candidate configuration is associated with (dependent) of the CHO target candidate configuration. This “dependency” between a CHO target candidate cell (and its CHO target candidate cell configuration) may be indicated to the UE in different signaling alternatives, so that the PScell target candidate configuration is either within a CPC configuration within the CHO target candidate cell configuration, or as a candidate PSCell configuration configured with the CHO target candidate cell configuration (i.e. in the same IE as the CHO target candidate configuration, but not within the CHO target candidate configuration). These signaling alternatives are later described in this document.

The present disclosure comprises methods for a UE to perform a conditional reconfiguration execution (e.g. CHO execution) and apply one or more reconfiguration message(s) for a selected target PCell for CHO and for a selected target PSCell. It also comprises how the UE determines the reconfiguration(s) for the selected PCell and selected PSCell to be applied when the CHO and/or CPC/CPA execution conditions have been fulfilled. There are different options related to the execution conditions being fulfilled, such as the following:
The CHO and the CPC/CPA conditions are both fulfilled.
The CHO conditions are fulfilled, but not the CPC/CPA conditions.
The CPC/CPA conditions are fulfilled, but not the CHO conditions.
Multiple target cells for CHO fulfil the conditions for CHO.
Multiple target cells for CPC/CPA fulfil the conditions for CPC/CPA.

The present disclosure includes solutions for how to handle the different cases.

According to some examples in the disclosure, the UE may receive an RRC Reconfiguration (e.g. from a network node operating as a Source MN (S-MN)). The RRC Reconfiguration may include at least one CHO target candidate cell with a CHO target candidate cell configuration (e.g. an RRCReconfiguration^{(CHO candidate)} including an MCG configuration to be applied upon fulfillment of an associated CHO execution condition), which is associated to one or more PSCell candidate cells. For each PSCell candidate, there may be a PSCell target candidate cell configuration and a CPC execution condition (e.g. one or more measurement identities related to a CPC measurement configuration).

The present disclosure also comprises solutions related to two signaling options for the association described above.

In a first signaling option, the CHO target candidate configuration and the configurations for an associated PSCell candidate cell (i.e. the PSCell target candidate cell configuration and a CPC execution condition) are signaled to the UE in the same IE CondReconfigToAddMod with one condReconfigId for both the CHO target candidate cell and PSCell target candidate.

In a second signaling option, the CHO target candidate configuration contains a CPC or CPA configuration, e.g. the CHO target candidate cell configuration includes the IE Conditional Reconfiguration information element (IE), with configuration(s) for one or more PSCell candidate cells and associated CPC execution conditions. The signaling details are further described in the text below.

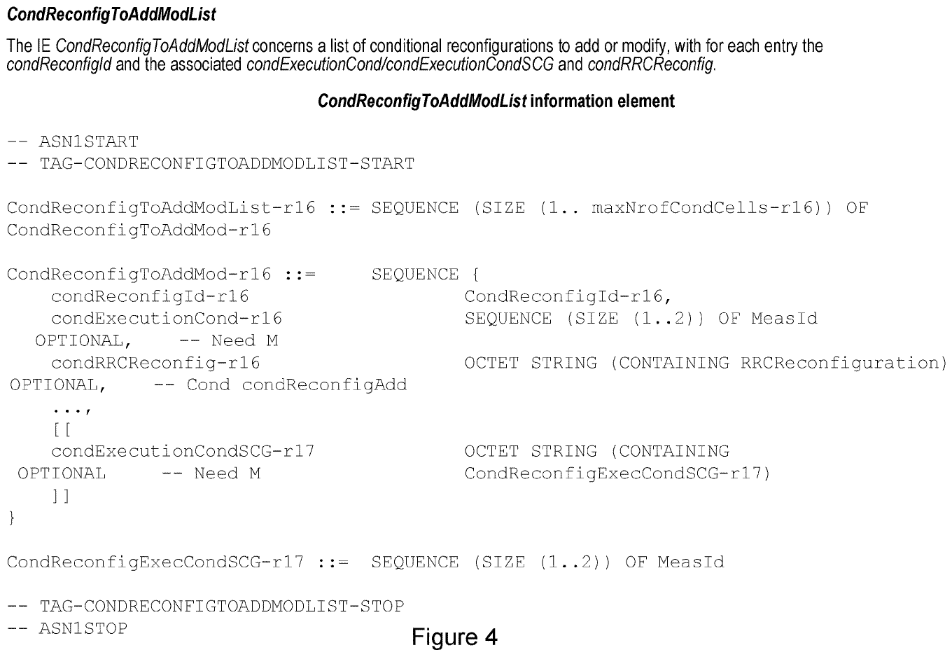

FIG. 4, for reference, shows an example configuration of conditional reconfigurations in 3GPP TS 38.331 v17.3.0, which are proposed in the following sections to be enhanced to implement the proposed solutions in RRC.

First signaling option: Execution of CHO with one or more associated PSCell target candidate cell(s) signaled in the same CondReconfigToAddMod

In a first signaling option, for at least one CHO target candidate cell, the CHO target candidate cell configuration, the CHO execution condition, and the configuration for the one or more associated candidate PSCell(s) (CPC execution condition and the PSCell target candidate cell configuration) are signaled to the UE in the same IE CondReconfigToAddMod with one condReconfigId for both configurations. The UE receives, in an RRC Reconfiguration message, a list of IE instances CondReconfigToAddMod. At least one

CondReconfigToAddMod contains the CHO execution condition (in condExecutionCond-r16) and the CPC execution conditions, for the associated PSCell target candidate cell, in a new parameter or IE (denoted here as condExecutionCondSCG-CHO-r18, and possibly comprising one or more measId(s) referring to a measurement configuration for CPC or CPA; other parameter or IE names may be adopted by 3GPP which cover the same functionality), which the UE may also evaluate. In this first signaling option, the CHO target candidate cell configuration and the PSCell target candidate configuration are both within the condRRCReconfig-r16 of IE OCTET STRING (CONTAINING RRCReconfiguration). That message may contain both an MCG configuration and an SCG configuration that the UE applies under certain conditions (later described).

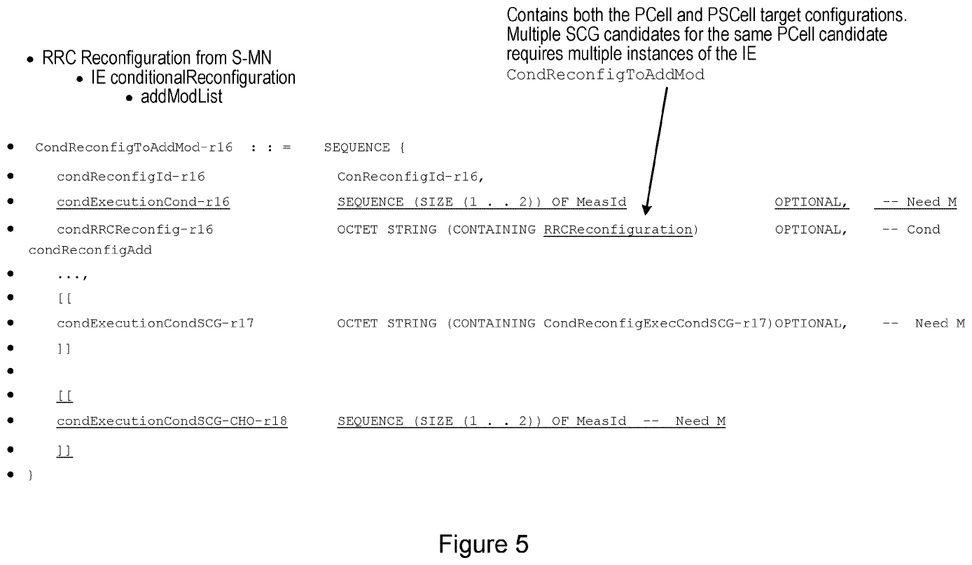

FIG. 5 shows an example of this first signaling option (with the PCell target configuration corresponding to the CHO target candidate configuration).

In that first signaling option, each IE CondReconfigAddMod can contain a single pair of a CHO target candidate cell and a candidate PSCell. In other words, in case the UE is configured with multiple candidate PSCell(s) associated to a given CHO target candidate cell, the UE can receive multiple instances of the IE CondReconfigAddMod, each having the same CHO target candidate cell, but possibly having different PSCell target candidate cells.

In an example, the UE may be configured with three CHO target candidate cells, denoted A, B and C, and three PSCell target candidate cells, denoted X1, X2 and X3, wherein the PSCell candidates X1 and X2 are candidates for (associated with) the CHO candidate cell A, and the PSCell candidates X2 and X3 are candidates for (associated with) the CHO candidate cell B, and there are no associated candidates PSCells for PCell C. It can be noted, in this example, that the PSCell candidate X2 is a candidate PSCell for both CHO target candidates A and B.

According to the first signaling option, in this example, the UE may receive a list of IE(s) CondReconfigToAddMod.

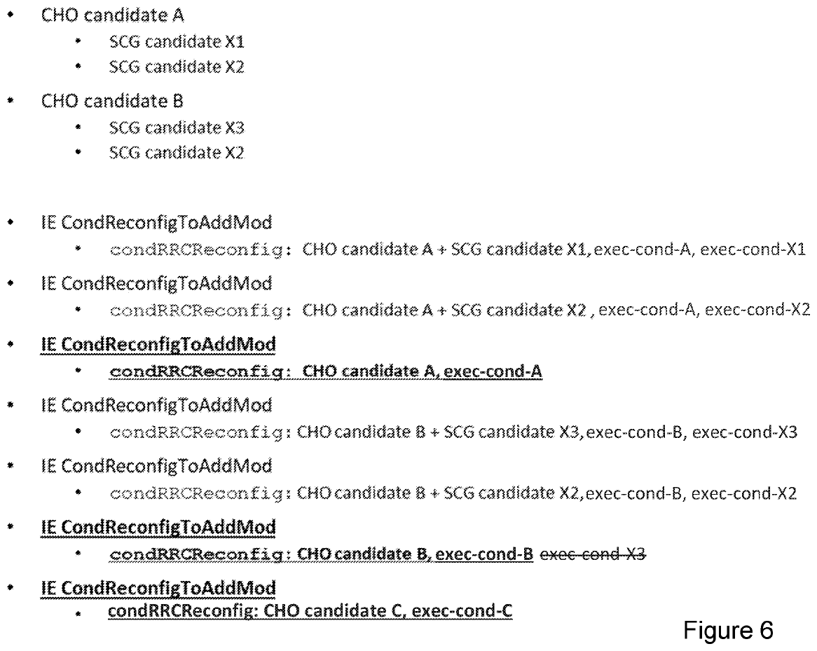

FIG. 6 shows an example of such a list of IE(s) CondReconfigToAddMod. As can be seen, for the CHO target candidate cell A, associated to multiple PSCell target candidate cell(s), the UE receives three instances of IE CondReconfigToAddMod for the CHO target candidate A: one with the configuration for the PSCell candidate X1, one with the configuration for the PSCell candidate X2, and one without any PSCell candidate configuration. Similarly, for the CHO target candidate cell B, also associated to multiple PSCell target candidate cell(s), the UE receives other three instances of IE CondReconfigToAddMod for the CHO target candidate B: one with the configuration for the PSCell candidate X3, one with the configuration for the PSCell candidate X2, and one without any PSCell candidate configuration. Finally, the UE receives another instance of IE CondReconfigToAddMod for the CHO target candidate C.

The present disclosure comprises methods for a UE performing a conditional reconfiguration execution (e.g. CHO execution) procedure when at least a conditional reconfiguration execution (e.g. CHO execution) condition is fulfilled for a CHO target candidate with at least one associated candidate PSCell, e.g. depending on whether the CPC execution condition associated to the at least one associated candidate PSCell is fulfilled.

An example method may comprise the UE receiving a message (RRCReconfiguration), and evaluating at least the CHO execution condition(s) for one or more CHO target candidate cells. When at least the CHO execution condition(s) is fulfilled, the example method may comprise the UE performing conditional reconfiguration execution (e.g. CHO execution) based on one or more CHO target candidate cell(s) for which the CHO execution condition is fulfilled (denoted here CHO triggered cells) and one or more of the following:
a. at least one candidate PSCell associated with a CHO target candidate cell;
b. the associated CPC/CPA execution condition i.e. the execution condition associated to the at least one candidate PSCell associated with a CHO target candidate cell;
   i. In the case of the first signaling option, the associated CPC/CPA execution condition may be within the IE CondReconfigToAddMod, and can be denoted e.g. condExecutionCondSCG-CHO-r18 OF SEQUENCE (SIZE (1 . . . 2)) OF MeasId.
c. the PSCell target candidate configuration.
   i. In the case of the first signaling option, both the configurations for both the CHO target candidate cell and the candidate PSCell may be within the same IE e.g. CondReconfigToAddMod, For example, the CHO target candidate cell configuration and the PSCell target candidate configuration may both be within the condRRCReconfig-r16 of IE OCTET STRING (CONTAINING RRCReconfiguration), within that IE.

In a set of embodiments, the UE may perform the following steps:
a. Receiving a message (e.g. RRC Reconfiguration) including a CHO configuration, wherein the CHO configuration includes at least:
   i. a CHO target candidate cell configuration and
   ii. a CHO execution condition associated to the CHO target candidate cell configuration,
b, wherein the CHO target candidate cell configuration (associated to a candidate PSCell) and including a PSCell target candidate configuration (e.g. candidate SCG configuration),
c. Wherein the candidate PScell has an associated CPC/CPA execution condition (one or more measId(s) associated to the CPC/CPA target candidate configuration).

In one set of embodiments, the CHO target candidate cell configuration and the candidate PScell configuration may be signaled in the same IE CondReconfigToAddMod with one condReconfigId. The UE may perform one of more of the following steps:
a. Evaluating whether the CHO execution condition is fulfilled and evaluating whether the CPA/CPC execution condition is fulfilled;
b. Determining that the execution conditions are fulfilled for at least a CHO target candidate cell.
c. In one option (denoted option C), first selecting the CHO target candidate cell.
   i. When the target cell for CHO has been selected, selecting a PSCell candidate:
      1. Applying the target configuration included in condReconfigRRC for the selected cell for CHO and the selected cell for CPC/CPA.
   ii. If there is no triggered candidate PSCell
      1. Applying the target n included in condReconfigRRC for the selected cell for CHO (e.g. which not have a candidate PSCell configuration)

In an alternative option (denoted option D), selecting the target cells for CHO and CPC/CPA as a joint selection.
a. Selecting as a first option a target cell for CHO if there also is a triggered cell for CPC/CPA for that triggered cell for CHO.
   i. Applying the target configuration (condReconfigRRC) for the selected cell for CHO and the selected cell for CPC/CPA.
b. If there is no triggered cell for CPC/CPA
   i. Applying the target configuration (condReconfigRRC) for the selected cell for CHO.

Option C: CPC conditions per CHO candidate are evaluated in 3GPP TS 38.331 v17.3.0, Section 5.3.5.13.6; The UE selects a CHO target candidate cell and, based on that, the UE selects one of the triggered candidate PSCell(s) associated to the selected CHO target candidate cell (if any is triggered).

A first example implementation (option C) in relation to 3GPP TS 38.331v17.3.0 (e.g. based on the first signaling) is as follows:

### 5.3.5.13.5 Conditional Reconfiguration Execution

| 1> | if more than one triggered cell exists: | |
|---|---|---|
| | 2> | select one of the triggered cells as the selected cell for conditional reconfiguration |
| | | execution; |
| 1> | else: | |
| | 2> | consider the triggered cell as the selected cell for conditional reconfiguration |
| | | execution; |
| 1> | if the selected cell is for CHO and at least one condReconfigId in which the | |
| | selected cell for CHO is configured contains a PSCell candidate configuration; or | |
| 1> | if the selected cell is for CHO and at least one condReconfigId in which the | |
| | selected cell for CHO is configured contains a CPC execution condition (e.g. | |
| | condExecutionCondSCG-CHO-r18); or | |
| 1> | if the selected cell is for CHO and at least one condReconfigId in which the | |
| | selected cell for CHO is configured contains a candidate SCG configuration): | |
| | 2> | if at least one triggered candidate PSCell exists; or |
| | 2> | if at least one candidate PSCell has fulfilled the CPC execution condition(s): |

| | |
|---|---|
| 3> | if more than one triggered candidate PSCell exists; or |
| 3> | if more than one candidate PSCell has fulfilled the CPC execution |

| condition(s): | |
|---|---|
| 4> | select one of the triggered candidate PSCell(s) associated to the selected |

| cell for CHO: | |
|---|---|
| 5> | apply the stored condRRCReconfig of the selected cell for CHO and the |

selected SCG candidate and perform the actions as specified in 5.3.5.3;

| | |
|---|---|
| 3> | else: |

| | |
|---|---|
| 4> | apply the stored condRRCReconfig of the selected cell for CHO and the |

selected PSCell candidate and perform the actions as specified in 5.3.5.3;

| | |
|---|---|
| 2> | else (i.e. no triggered candidate PSCell): |

| | |
|---|---|
| 3> | apply the stored condRRCReconfig of the selected cell which does not |

contain an associated candidate PSCell configuration within and perform the
actions as specified in 5.3.5.3;

A second example implementation (option C) in relation to 3GPP TS 38.331v17.3.0 (e.g. based on the first signaling) is as follows:

### 5.3.5.13.5 Conditional Reconfiguration Execution

### The UE Shall:

| 1> | if more than one triggered cell exists: | |
|---|---|---|
| | 2> | select one of the triggered cells as the selected cell for conditional reconfiguration |
| | | execution; |
| 1> | else: | |
| | 2> | consider the triggered cell as the selected cell for conditional reconfiguration |
| | | execution; |
| 1> | if the selected cell is for CHO and at least one condReconfigId in which the | |
| | selected cell for CHO is configured contains a PSCell candidate configuration; or | |
| 1> | if the selected cell is for CHO and at least one condReconfigId in which the | |
| | selected cell for CHO is configured contains a CPC execution condition (e.g. | |
| | condExecutionCondSCG-CHO-r18); or | |
| 1> | if the selected cell is for CHO and at least one condReconfigId in which the | |
| | selected cell for CHO is configured contains a candidate SCG configuration): | |
| | 2> | if at least one triggered candidate PSCell exists; or |
| | 2> | if at least one candidate PSCell has fulfilled the CPC execution condition(s): |

| | |
|---|---|
| 3> | if more than one triggered candidate PSCell exists; or |
| 3> | if more than one candidate PSCell has fulfilled the CPC execution |

| condition(s): | |
|---|---|
| 4> | select one of the triggered candidate PSCell(s) associated to the selected |

| cell for CHO: | |
|---|---|
| 5> | apply the stored condRRCReconfig of the selected cell for CHO and the |

selected SCG candidate and perform the actions as specified in 5.3.5.3;

| | |
|---|---|
| 3> | else: |

| | |
|---|---|
| 4> | apply the stored condRRCReconfig of the selected cell for CHO and the |

selected PSCell candidate and perform the actions as specified in 5.3.5.3;

| | |
|---|---|
| 2> | else (i.e. no triggered candidate PSCell): |

| | |
|---|---|
| 3> | apply the stored condRRCReconfig of the selected cell for which the |

condReconfigId does not contain a CPC execution condition (e.g.
condExecutionCondSCG-CHO-r18) and perform the actions as specified in
5.3.5.3;

A third example implementation (option C) in relation to 3GPP TS 38.331v17.3.0 (e.g. based on the first signaling) is as follows:

### 5.3.5.13.5 Conditional Reconfiguration Execution

### The UE Shall:

| 1> | if more than one triggered cell exists: | |
|---|---|---|
| | 2> | select one of the triggered cells as the selected cell for conditional reconfiguration |
| | | execution; |
| 1> | else: | |
| | 2> | consider the triggered cell as the selected cell for conditional reconfiguration |
| | | execution; |
| 1> | if the selected cell is for CHO and at least one condReconfigId in which the | |
| | selected cell for CHO is configured contains a PSCell candidate configuration; or | |
| 1> | if the selected cell is for CHO and at least one condReconfigId in which the | |
| | selected cell for CHO is configured contains a CPC execution condition (e.g. | |
| | condExecutionCondSCG-CHO-r18); or | |
| 1> | if the selected cell is for CHO and at least one condReconfigId in which the | |
| | selected cell for CHO is configured contains a candidate SCG configuration): | |
| | 2> | if at least one triggered candidate PSCell exists; or |
| | 2> | if at least one candidate PSCell has fulfilled the CPC execution condition(s): |

| | |
|---|---|
| 3> | if more than one triggered candidate PSCell exists; or |
| 3> | if more than one candidate PSCell has fulfilled the CPC execution |

| condition(s): | |
|---|---|
| 4> | select one of the triggered candidate PSCell(s) associated to the selected |

| cell for CHO: | |
|---|---|
| 5> | apply the stored condRRCReconfig of the selected cell for CHO and the |

selected SCG candidate and perform the actions as specified in 5.3.5.3;

| | |
|---|---|
| 3> | else: |

| | |
|---|---|
| 4> | apply the stored condRRCReconfig of the selected cell for CHO and the |

selected PSCell candidate and perform the actions as specified in 5.3.5.3;

| | |
|---|---|
| 2> | else (i.e. no triggered candidate PSCell): |

| | |
|---|---|
| 3> | apply the MCG configuration of the stored condRRCReconfig of the selected |

cell and perform the actions as specified in 5.3.5.3;

Option D: A joint selection of CHO target candidate cell and candidate PSCell is performed.

An example implementation (option D) in relation to 3GPP TS 38.331 v17.3.0 (e.g. based on the first signaling) is as follows:

### The UE Shall:

| 1> | if at least one triggered cell is for CHO and has at least one associated candidate | |
|---|---|---|
| | SCG configuration: | |
| | 2> | if at least one triggered candidate SCG exists: |

| | |
|---|---|
| 3> | select one of the triggered CHO candidate cells and the associated triggered |

| candidate SCG cell; | |
|---|---|
| 4> | apply the stored condRRCReconfig of the selected cell for CHO and the |

selected SCG candidate and perform the actions as specified in 5.3.5.3;

| | |
|---|---|
| 2> | else (no triggered candidate SCG exists): |

| | |
|---|---|
| 3> | select one of the triggered CHO candidate cells; |

| | |
|---|---|
| 4> | apply the stored condRRCReconfig of the selected cell for CHO and |

perform the actions as specified in 5.3.5.3;

| 1> | else (at least one triggered cell is for CHO and there is no associated candidate | |
|---|---|---|
| | SCG configuration): | |
| | 2> | apply the stored condRRCReconfig of the selected cell which does not contain |

an associated candidate SCG configuration within and perform the actions as
specified in 5.3.5.3;

An example implementation (option D) in relation to 3GPP TS 38.331 v17.3.0 (e.g. based on the first signaling) is as follows:

### The UE Shall:

| 1> | if at least one triggered cell is for CHO and has at least one associated candidate | |
|---|---|---|
| | SCG configuration: | |
| | 2> | if at least one triggered candidate SCG exists: |

| | |
|---|---|
| 3> | select one of the triggered CHO candidate cells and the associated triggered |

| candidate SCG cell; | |
|---|---|
| 4> | apply the stored condRRCReconfig of the selected cell for CHO and the |

selected SCG candidate and perform the actions as specified in 5.3.5.3;

| | |
|---|---|
| 2> | else (no triggered candidate SCG exists): |

| | |
|---|---|
| 3> | select one of the triggered CHO candidate cells; |

| | |
|---|---|
| 4> | apply the stored condRRCReconfig of the selected cell for CHO and |

perform the actions as specified in 5.3.5.3;

| 1> | else (at least one triggered cell is for CHO and there is no associated candidate | |
|---|---|---|
| | SCG configuration): | |
| | 2> | (ALTERNATIVE) apply the stored condRRCReconfig of the selected cell which |

does not contain an associated candidate SCG configuration and perform the
actions as specified in 5.3.5.3;

An example implementation (option D) in relation to 3GPP TS 38.331 v17.3.0 (e.g. based on the first signaling) is as follows:

### The UE Shall:

| 1> | if at least one triggered cell is for CHO and has at least one associated candidate | |
|---|---|---|
| | SCG configuration: | |
| | 2> | if at least one triggered candidate SCG exists: |

| | |
|---|---|
| 3> | select one of the triggered CHO candidate cells and the associated triggered |

| candidate SCG cell; | |
|---|---|
| 4> | apply the stored condRRCReconfig of the selected cell for CHO and the |

selected SCG candidate and perform the actions as specified in 5.3.5.3;

| | |
|---|---|
| 2> | else (no triggered candidate SCG exists): |

| | |
|---|---|
| 3> | elect one of the triggered CHO candidate cells; |

| | |
|---|---|
| 4> | apply the stored condRRCReconfig of the selected cell for CHO and |

perform the actions as specified in 5.3.5.3;

| 1> | else (at least one triggered cell is for CHO and there is no associated candidate | |
|---|---|---|
| | SCG configuration): | |
| | 2> | (ALTERNATIVE) apply the stored condRRCReconfig of the selected cell for |

which the condReconfigId does not contain an SCG execution condition and
perform the actions as specified in 5.3.5.3;

An example implementation (option D) in relation to 3GPP TS 38.331 v17.3.0 (e.g. based on the first signaling) is as follows:

### The UE Shall:

| 1> | if at least one triggered cell is for CHO and has at least one associated candidate | |
|---|---|---|
| | SCG configuration: | |
| | 2> | if at least one triggered candidate SCG exists: |

| | |
|---|---|
| 3> | select one of the triggered CHO candidate cells and the associated triggered |

| candidate SCG cell; | |
|---|---|
| 4> | apply the stored condRRCReconfig of the selected cell for CHO and the |

selected SCG candidate and perform the actions as specified in 5.3.5.3;

| | |
|---|---|
| 2> | else (no triggered candidate SCG exists): |

| | |
|---|---|
| 3> | select one of the triggered CHO candidate cells; |

| | |
|---|---|
| 4> | apply the stored condRRCReconfig of the selected cell for CHO and |

perform the actions as specified in 5.3.5.3;

| 1> | else (at least one triggered cell is for CHO and there is no associated candidate | |
|---|---|---|
| | SCG configuration): | |
| | 2> | (ALTERNATIVE) apply the MCG configuration of the stored |

condRRCReconfig of the selected cell and perform the actions as specified in
5.3.5.3;

Second signaling option: Execution of CHO with associated CPC/CPA when the CHO target candidate cell configuration comprises the CPC/CPA configurations.

In a second signaling option, in order to provide, to the UE, CPC/CPA configurations (e.g. as a conditionalReconfiguration field of IE ConditionalReconfiguration) that are associated to the CHO configuration, the CPC/CPA configurations (e.g. including the CPC/CPA target candidate cell configuration and the associated execution conditions for CPC/CPA) can be included within the CHO target candidate cell configuration (i.e. the condRRCReconfig in the CondReconfigToAddMod for the CHO configuration). The UE may then evaluate the execution conditions for those CPC/CPA configurations, e.g. in parallel with the evaluation of the execution condition for the associated CHO configuration.

In an example, the UE may be configured with three target candidate cells (PCells) for CHO, denoted A, B and C, and three target candidate cells (PSCells) for CPC/CPA, denoted X1, X2 and X3, where the CPC/CPA candidate cells X1 and X2 are candidates for (associated to) the CHO candidate cell A, and CPC/CPA candidate cells X2 and X3 are candidates for (associated to) the CHO candidate cell B, and there are no candidate PSCells for PCell C. It can be noted, in this example, that the CPC/CPA candidate cell X2 is a candidate PSCell for both candidate PCells A and B.

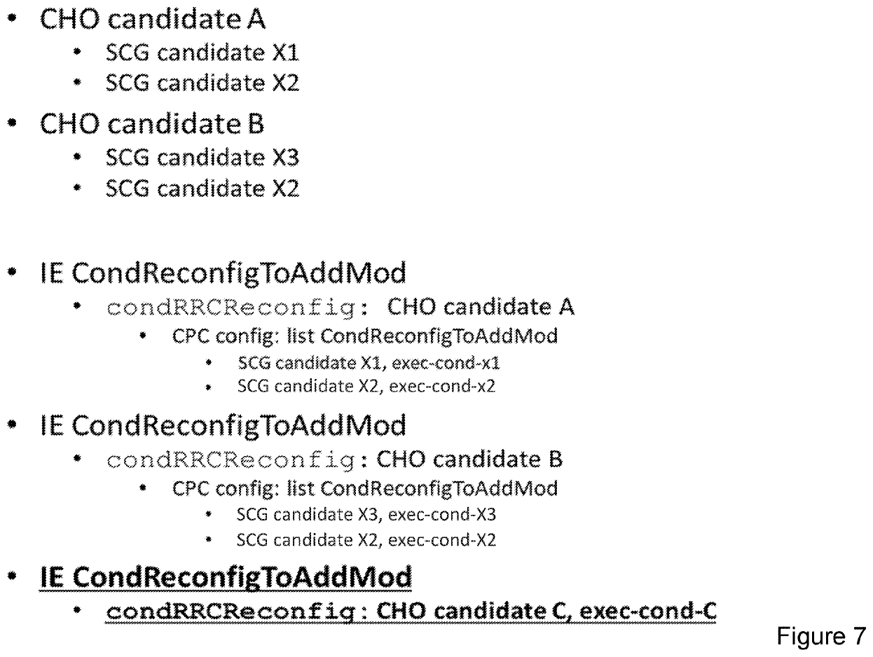

FIG. 7 shows an example of this second signaling option. In this second signaling option, the CPC/CPA candidate cell(s) (PSCell(s)) are included within the associated CHO target candidate cell configuration. There can then be a single conditional reconfiguration (CondReconfigToAddMod instance) per CHO candidate cell even if there are multiple associated CPC/CPA candidate cells.

The present disclosure comprises methods for a UE when one or multiple executions conditions are fulfilled.

According to certain embodiments, a method for a UE is disclosed, the method may comprise:
a. Receiving a message (e.g. RRC Reconfiguration) including a CHO configuration. The CHO configuration may include at least one or both of:
   i. a CHO target candidate cell configuration (e.g. embedded RRCReconfiguration), and
   ii. a CHO execution condition associated to the CHO target candidate cell configuration,
b. The CHO target candidate cell configuration is associated with a candidate SCG configuration (referred here as a CPC or CPA configuration). The CPC/CPA configuration may include one or both of:
   i. a CPC/CPA target candidate configuration (e.g. candidate SCG configuration), and
   ii. an associated CPC/CPA execution condition (e.g. one or more measId(s) associated to the CPC/CPA target candidate configuration)
c. In at least one option, the CPC/CPA configurations may be signaled within the condRRCReconfig of the associated CHO configuration (i.e. within the CHO target candidate cell configuration).
d. Evaluating whether the CHO execution condition is fulfilled and evaluating whether the CPA/CPC execution condition is fulfilled,
e. Determining that the execution conditions are fulfilled for at least one of the CHO configurations, i.e. for at least one target candidate PCell of a CHO configuration.
f. In one option, first selecting the target cell (PCell) for CHO and then selecting a target cell (PSCell) for CPC/CPA.
   i. In one example, e.g. if CHO execution conditions are fulfilled for more than one CHO target candidate cells, the UE may select a target cell for CHO
   ii. If the CHO target candidate cell configuration (condRRCReconfig) of the selected cell includes at least one CPC or CPA configuration:
      1. If the execution conditions are fulfilled for at least one of the PSCell target candidate cells in the CPC or CPA configurations that are included in the CHO configuration of the selected cell (PCell), selecting a target cell (PSCell) for CPC or CPA.
g. In one option, selecting the target cell (PCell) for CHO based on whether there is at least one PScell candidate in the CPC/CPA configuration with fulfilled execution conditions associated to the CHO configuration.
   i. If execution conditions are fulfilled for more than one CHO target candidate cell, the selection of the target cell for CHO may be performed by comparing if any of those CHO configurations are associated with (included in condRRCReconfig) a CPC or CPA configuration for which the execution conditions are fulfilled.
      1. If only one of the CHO candidate cell(s) for which the execution conditions are fulfilled have a CHO candidate cell configuration which includes a CPC or CPA configuration for which the execution conditions are fulfilled, the target cell of that CHO configuration is selected. If the CHO configuration includes more than one CPC or CPA configuration for which the execution conditions are fulfilled, one of those target cells (PSCell) for CPC/CPA is selected.
         a. In case more than one, but only a subset, of the CHO configurations, for which the execution conditions are fulfilled, include at least one CPC or CPA configuration for which the execution conditions are fulfilled, the target cell of one of those CHO configurations (i.e. of this subset of CHO configurations) is selected.
      2. If more than one of the CHO configurations, for which the execution conditions are fulfilled, include at least one CPC or CPA configuration for which the execution conditions are fulfilled, one of those target cells (PCell) for CHO is selected.
   h. Executing the CHO conditional reconfiguration by applying the CHO target candidate cell configuration (i.e. the condRRCReconfig in the CHO configuration) for the selected cell (PCell) and (possibly) executing the associated CPC or CPA conditional reconfiguration by applying the CPC/CPA target candidate cell configuration, i.e. the condRRCReconfig in the CPC/CPA configuration (for the selected PSCell, if any) that is included within the CHO target candidate cell configuration:
      i. In one option, the UE may first apply (and execute) the CHO target candidate cell configuration and then apply (and execute) the CPC/CPA target candidate cell configuration.
      ii. In one option, the UE may generate a configuration consisting of the CHO target candidate cell configuration for the selected cell (PCell) and the associated CPC/CPA target candidate cell configuration for the selected cell (PSCell). It may then apply (and execute) this combined configuration. In one alternative, the UE may generate the combined configuration by adding the associated CPC/CPA target candidate cell configuration for the selected cell (PSCell) on top of the CHO target candidate cell configuration, i.e. the one that the CPC/CPA configuration was included within. In one example, the CPC/CPA target candidate cell configuration may be a delta configuration in relation to the CHO target candidate cell configuration that it is included within.
      iii. In one option, the UE may select only a target cell (PCell) for CHO and it may then apply (and execute) the CHO target candidate cell configuration.

If the CHO configuration is associated to multiple CPC or CPA configurations (i.e. there are multiple CPC or CPA configurations within the CHO target candidate cell configuration) and the execution condition for one of those CPC/CPA configurations is fulfilled when the CHO execution condition is fulfilled, the UE may then also apply (and execute) the corresponding CPC/CPA target candidate cell configuration when the CHO target candidate cell configuration is applied (and executed). Since the CPC/CPA configurations are included within the CHO target candidate cell configuration they are then part of the UE configuration in the target PCell as part of applying the CHO target candidate cell configuration. The same can be true for the case where execution conditions for none of the associated (i.e. included within the CHO target candidate cell configuration that is applied (or executed)) CPC/CPA configurations are fulfilled, or if no PSCell has been selected from any of those CPC/CPA configurations.

In one embodiment, the UE may not store (e.g. in VarConditionalReconfig) any of the CPC/CPA configurations that are included in the CHO target candidate cell configuration, when the UE applies (or executes) the CHO target candidate cell configuration due to the fact that the associated CHO execution condition is fulfilled, if the associated CPC/CPA execution for at least one of those CPC/CPA configurations is also fulfilled and the corresponding CPC/CPA target candidate cell configuration is also applied (or executed).

In one alternative, the UE may store all the CPA/CPC configurations that are included within the CHO target candidate cell configuration that is applied (or executed), except for the CPA or CPC configuration for which the associated execution condition is also fulfilled and the UE may then apply (or execute) the included CPC/CPA target candidate cell configuration. In other words, in this alternative, the UE may store the other CPC/CPA configurations, i.e. the ones that have not been applied (or executed) and thus correspond to different configurations than the configuration of the UE after the CHO+CPC/CPA execution procedure(s).

In one alternative, the UE may store the included conditional reconfigurations (CPC or CPA configurations) depending on the type of conditional reconfiguration (CPC or CPA) for which the target candidate cell configuration is applied (or executed) together with the CHO execution. In one example, if the UE applies (or executes) a CPC target candidate cell configuration, the UE may store the other CPC configurations that are included in the same CHO target candidate cell configuration. If the UE then instead applies (or executes) a CPA target candidate cell configuration, the UE may not store the other CPA configurations that are included in the same CHO target candidate cell configuration.

In one alternative, when the UE applies (or executes) a CPA target candidate cell configuration, the UE may store the other CPA configurations that are included in the same CHO target candidate cell configuration, but it may then consider them as CPC configurations. In one alternative, the UE may receive from the network a different execution condition for the CPA configuration in order to be used as a CPC configuration in this case.

In one alternative, the UE may receive an indication from the network about which CPC or CPA configurations (which are included within the CHO target candidate cell configuration that is applied) to keep and which to release when the CHO target candidate cell configuration is applied (or executed). This indication can be independent of whether any of the included CPC/CPA target candidate cell configurations is applied (or executed) in conjunction with that the CHO target candidate cell configuration is applied (or executed). In one example, the indication from the network may be included within each CPC/CPA configuration. In another example, the indication may be included within the CHO target candidate cell configuration, but outside the CPA/CPC configurations. The indication can be (but is not limited to) a single indication that is applicable to multiple (or all) of the included CPC/CPA configurations, or it can be an indication per type of conditional reconfiguration, or it can be an indication per included CPC/CPA configuration. The indication may also indicate how a stored CPC/CPA configuration is to be handled by the UE when in the target PCell, e.g. whether it is to consider the CPC/CPA configuration(s) as applicable or not (i.e. whether the UE is to perform evaluation of the execution condition for the CPC/CPA configuration or not, or whether the UE is to execute the included CPC/CPA target candidate cell configurations in case the associated execution condition is fulfilled).

An example implementation in relation to 3GPP TS 38.331 v17.3.0, where the implemented additions/changes according to the disclosure are underlined, is provided below.

In this example, the UE first selects a CHO configuration (PCell) and then a CPC/CPA configuration (PSCell) that fulfill execution conditions.

### 5.3.5.13.5 Conditional Reconfiguration Execution

### The UE Shall:

| 1> | if more than one triggered cell exists: | |
|---|---|---|
| | 2> | select one of the triggered cells as the selected cell for conditional |
| | | reconfiguration execution; |
| 1> | else: | |
| | 2> | consider the triggered cell as the selected cell for conditional reconfiguration |
| | | execution; |
| 1> | if the selected cell is for CHO and the stored condRRCReconfig of the selected cell | |
| | contains a CPC/ CPA configuration (conditionalReconfiguration): | |
| | 2> | if at least one triggered CPC/CPA candidate cell exists for the selected cell for |

| CHO: | |
|---|---|
| 3> | if more than one triggered CPC/CPA candidate cells exists: |

| | |
|---|---|
| 4> | select one of the triggered CPC/CPA candidate cells associated to the |

| selected cell for CHO: | |
|---|---|
| 5> | apply the stored condRRCReconfig of the selected cell for CHO (FFS |
| | except the IE ConditionalReconfiguration, FFS delete the IE |
| | ConditionalReconfiguration) and perform the actions as specified in |
| | 5.3.5.3; |
| 5> | apply the stored condRRCReconfig of the selected CPA/CPC candidate |

cell and perform the actions as specified in 5.3.5.3;

| | |
|---|---|
| 2> | else (there is no triggered CPC/CPA candidate cell for the selected cell for |

| CHO): | |
|---|---|
| 3> | apply the stored condRRCReconfig of the selected cell for CHO (FFS except |

the IE ConditionalReconfiguration, FFS delete the IE
ConditionalReconfiguration) and perform the actions as specified in 5.3.5.3;

| 1> | else: | |
|---|---|---|
| | 2> | for the selected cell of conditional reconfiguration execution: |

| | |
|---|---|
| 3> | apply the stored condRRCReconfig of the selected cell and perform the |

actions as specified in 5.3.5.3;

NOTE: If multiple New Radio (NR) cells are triggered in conditional reconfiguration

execution, it is up to UE implementation which one to select, e.g. the UE
considers beams and beam quality to select one of the triggered cells for
execution.

Another example implementation in relation to 3GPP TS 38.331 v17.3.0 is as follows:

### 5.3.5.13.5 Conditional Reconfiguration Execution

### The UE Shall:

| 1> | if more than one triggered cell exists: | |
|---|---|---|
| | 2> | select one of the triggered cells as the selected cell for conditional |
| | | reconfiguration execution; |
| 1> | else: | |
| | 2> | consider the triggered cell as the selected cell for conditional reconfiguration |
| | | execution; |
| 1> | if the selected cell is for CHO and the stored condRRCReconfig of the selected cell | |
| | contains a CPC/ CPA configuration (conditionalReconfiguration): | |
| | 2> | if at least one triggered CPC/CPA candidate cell exists for the selected cell for |

| CHO: | |
|---|---|
| 3> | if more than one triggered CPC/CPA candidate cells exists: |

| | |
|---|---|
| 4> | select one of the triggered CPC/CPA candidate cells associated to the |

| selected cell for CHO: | |
|---|---|
| 5> | apply the stored condRRCReconfig of the selected cell for CHO (FFS |
| | except the IE ConditionalReconfiguration FFS delete the IE |
| | ConditionalReconfiguration) and perform the actions as specified in |
| | 5.3.5.3; |
| 5> | apply the stored condRRCReconfig of the selected CPA/CPC candidate |

cell and perform the actions as specified in 5.3.5.3;

****

| | |
|---|---|
| 4> | select one of the triggered CPC/CPA candidate cells associated to the |

| selected cell for CHO: | |
|---|---|
| 5> | store the stored condRRCReconfig of the selected CPA/CPC candidate |
| | cell in Var-Blah; |
| 5> | release the IE ConditionalReconfiguration within the stored |
| | condRRCReconfig of the selected CPA/CPC candidate cell; |
| 5> | apply the stored condRRCReconfig of the selected cell for CHO and |
| | perform the actions as specified in 5.3.5.3; |
| 5> | apply the stored Var-Blah and perform the actions as specified in |

5.3.5.3;

| | |
|---|---|
| 3> | else: |

| | |
|---|---|
| 4> | apply the stored condRRCReconfig of the selected cell for CHO and the |

selected SCG candidate and perform the actions as specified in 5.3.5.3;

| | |
|---|---|
| 2> | else (there is no triggered candidate SCG): |

| 3> | apply the stored condRRCReconfig of the selected cell which does not contain |
|---|---|
| | an associated candidate SCG configuration within and perform the actions as |
| | specified in 5.3.5.3; |
| 3> | (ALTERNATIVE) apply the stored condRRCReconfig of the selected cell |
| | which does not contain an associated candidate SCG configuration and |
| | perform the actions as specified in 5.3.5.3; |
| 3> | (ALTERNATIVE) apply the stored condRRCReconfig of the selected cell for |
| | which the condReconfigId does not contain an SCG execution condition and |
| | perform the actions as specified in 5.3.5.3; |
| 3> | (ALTERNATIVE) apply the MCG configuration of the stored |

condRRCReconfig of the selected cell and perform the actions as specified in
5.3.5.3;

Although various embodiments and methods are disclosed above, the present disclosure encompasses all permissible combinations and permutations thereof. Furthermore, the disclosed methods may be performed by a UEs, network nodes, or other apparatuses, as disclosed in more detail below.

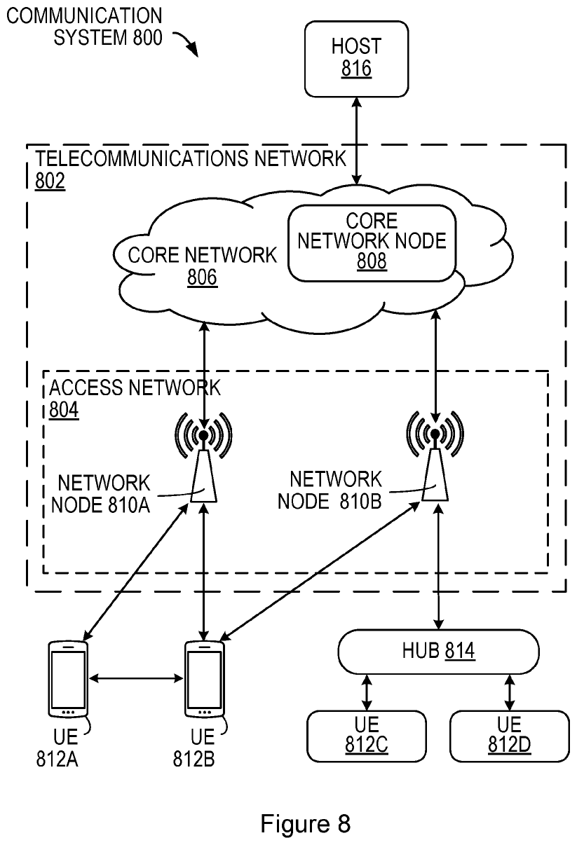

FIG. 8 shows an example of a communication system 800 in accordance with some embodiments.

In the example, the communication system 800 includes a telecommunication network 802 that includes an access network (AN) 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC). In the example, the hub 814 communicates with the access network 804 to facilitate

indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

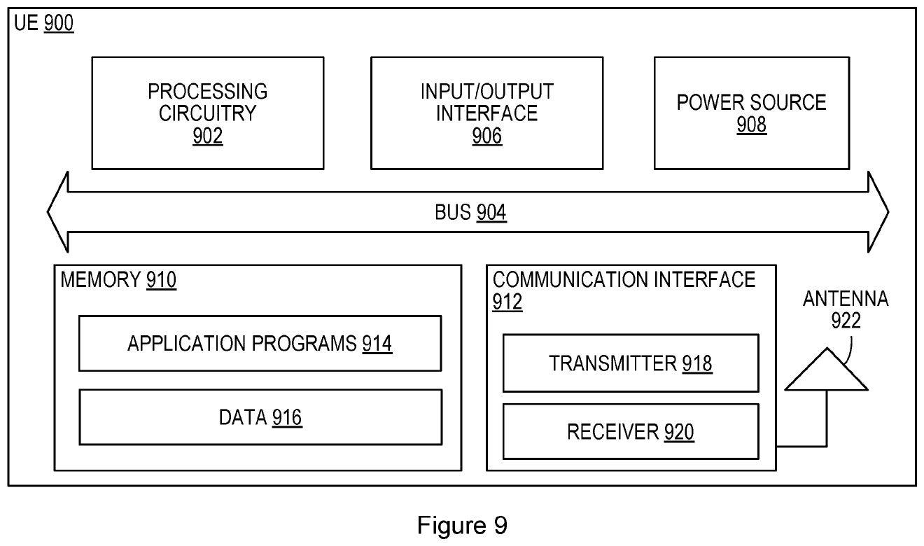

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

The processing circuitry 902 may be configured to cause the UE 900 to perform the first method described earlier with reference to FIG. 3, the second method described earlier, or any other method described herein in relation to the UE.

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

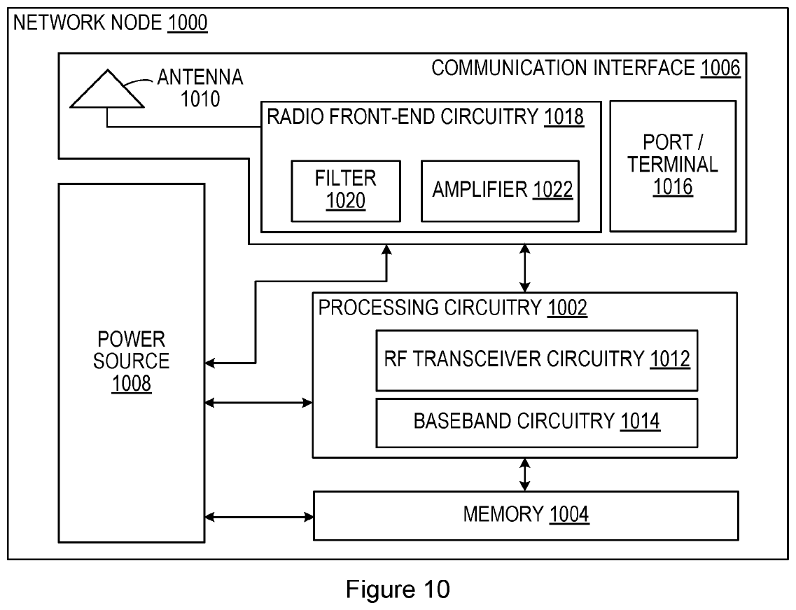

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

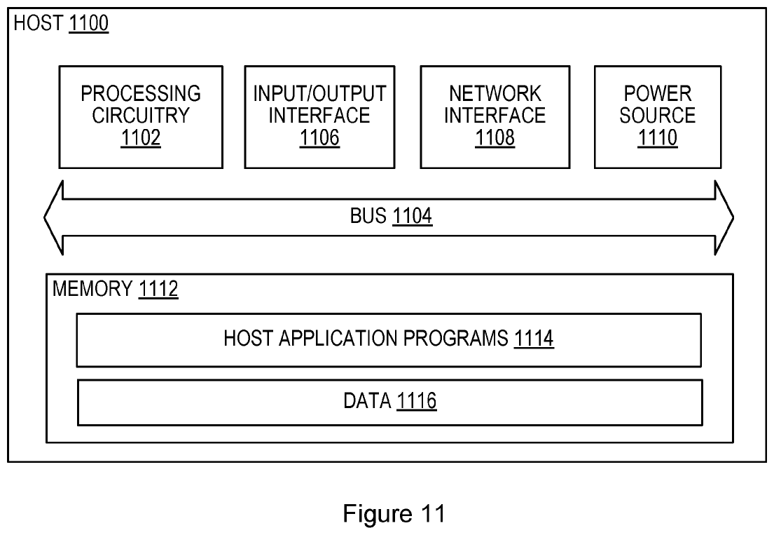

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC),

Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

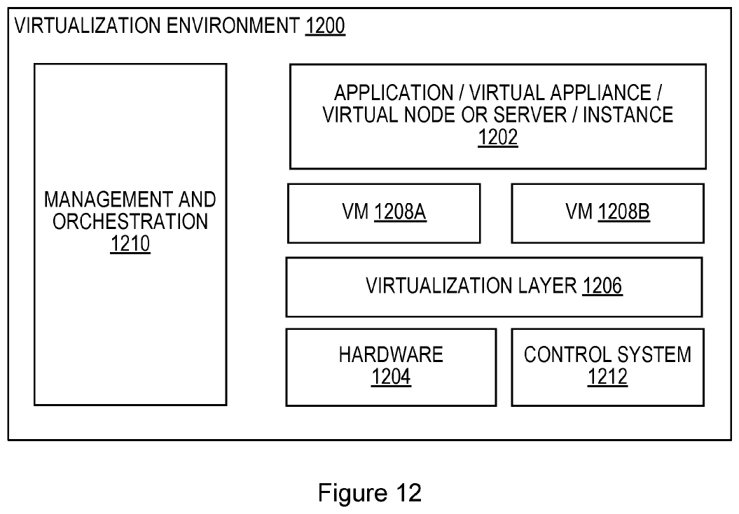

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

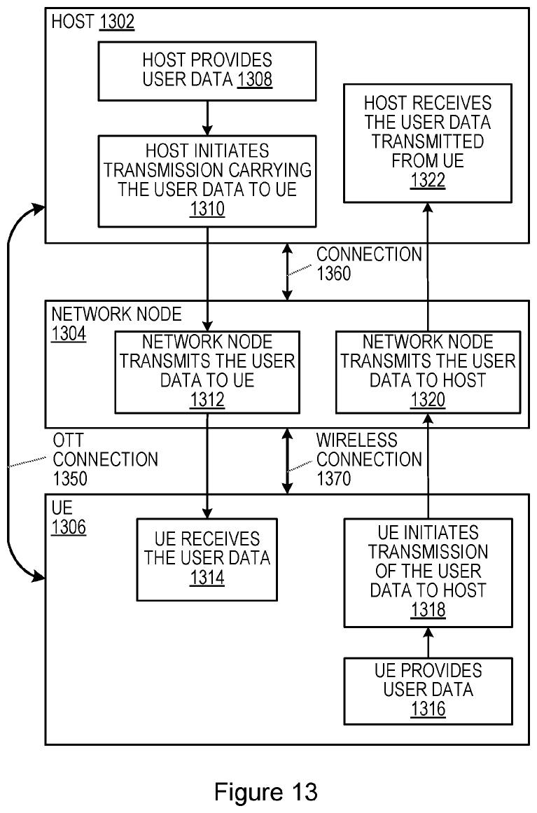

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve at least the latency and power consumption, and thereby provide benefits such as reduced user waiting time, better responsiveness, and extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data. In some examples, a measurement procedure may be provided for the purpose of

monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306.

In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Other embodiments of the present disclosure are defined in the following numbered statements:
Statement 1. A method performed by a user equipment for performing a conditional reconfiguration execution (e.g., CHO execution), the method according to any of the embodiments disclosed above.
Statement 2. The method of the previous Statement, further comprising:
   providing user data; and
   forwarding the user data to a host via the transmission to the network node.
Statement 3. A method performed by a network node for performing a conditional reconfiguration execution, the method comprising any of the embodiments disclosed above.
Statement 4. The method of the previous Statement, further comprising:
   obtaining user data; and
   forwarding the user data to a host or a user equipment.
Statement 5. A user equipment for performing a conditional reconfiguration execution, comprising:
   processing circuitry configured to perform any of the steps of Statement 1 or 2; and
   power supply circuitry configured to supply power to the processing circuitry.
Statement 6. A network node for performing a conditional reconfiguration execution, the network node comprising:
   processing circuitry configured to perform any of the steps of Statement 3 or 4;
   power supply circuitry configured to supply power to the processing circuitry.
Statement 7. A user equipment (UE) for performing a conditional reconfiguration execution, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of Statement 1 or 2;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
Statement 8. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of Statement 3 or 4 to transmit the user data from the host to the UE.
Statement 9. The host of the previous Statement, wherein:
   the processing circuitry of the host is configured to execute a host application that provides the user data; and
   the UE comprises processing circuitry configured to execute a client application associated with the host application to receive the transmission of user data from the host.
Statement 10. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of Statement 3 or 4 to transmit the user data from the host to the UE.
Statement 11. The method of the previous Statement, further comprising, at the network node, transmitting the user data provided by the host for the UE.
Statement 12. The method of any of the previous 2 Statements, wherein the user data is provided at the host by executing a host application that interacts with a client application executing on the UE, the client application being associated with the host application.
Statement 13. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of Statement 3 or 4 to transmit the user data from the host to the UE.
Statement 14. The communication system of the previous Statement, further comprising:
   the network node; and/or
   the UE.
Statement 15. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of Statement 3 or 4 to receive the user data from a user equipment (UE) for the host.
Statement 16. The host of the previous 2 Statements, wherein:
   the processing circuitry of the host is configured to execute a host application that receives the user data; and
   the host application is configured to interact with a client application executing on the UE, the client application being associated with the host application.
Statement 17. The host of the any of the previous 2 Statements, wherein the initiating receipt of the user data comprises requesting the user data.
Statement 18. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of Statement 3 or 4 to receive the user data from the UE for the host.
Statement 19. The method of the previous Statement, further comprising at the network node, transmitting the received user data to the host.
Statement 20. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of Statement 1 or 2 to receive the user data from the host.
Statement 21. The host of the previous Statement, wherein the cellular network further includes a network node configured to communicate with the UE to transmit the user data to the UE from the host.
Statement 22. The host of the previous 2 Statements, wherein:
   the processing circuitry of the host is configured to execute a host application, thereby providing the user data; and
   the host application is configured to interact with a client application executing on the UE, the client application being associated with the host application.
Statement 23. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of Statement 1 or 2 to receive the user data from the host.
Statement 24. The method of the previous Statement, further comprising:
   at the host, executing a host application associated with a client application executing on the UE to receive the user data from the host application.
Statement 25. The method of the previous Statement, further comprising:
   at the host, transmitting input data to the client application executing on the UE, the input data being provided by executing the host application,
   wherein the user data is provided by the client application in response to the input data from the host application.
Statement 26. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of Statement 1 or 2 to transmit the user data to the host.
Statement 27. The host of the previous Statement, wherein the cellular network further includes a network node configured to communicate with the UE to transmit the user data from the UE to the host.
Statement 28. The host of the previous 2 Statements, wherein:
   the processing circuitry of the host is configured to execute a host application, thereby providing the user data; and
   the host application is configured to interact with a client application executing on the UE, the client application being associated with the host application.
Statement 29. A method implemented by a host configured to operate in a communication system that further includes a network node and a user equipment (UE), the method comprising:
   at the host, receiving user data transmitted to the host via the network node by the UE, wherein the UE performs any of the steps of Statement 1 or 2 to transmit the user data to the host.
Statement 30. The method of the previous Statement, further comprising:
   at the host, executing a host application associated with a client application executing on the UE to receive the user data from the UE.
Statement 31. The method of the previous 2 Statements, further comprising:
   at the host, transmitting input data to the client application executing on the UE, the input data being provided by executing the host application,
   wherein the user data is provided by the client application in response to the input data from the host application.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

### Appendix

### 3GPP TSG-RAN WG2 #121

### Athens, Greece, 2023 Feb. 27-2023 Mar. 3

### R2-2301341

### Agenda Item: 8.4.4

### Source: Ericsson

Title: CHO with associated CPC or CPA

### Document for: Discussion, Decision

### 1 Introduction

The rel-18 work on further NR mobility enhancements is described in the WID in 0. The WID includes an objective related to specifying CHO configuration including both a target MCG and target candidate SCGs for CPAC (objective 4):
4. To specify CHO including target MCG and candidate SCGs for CPC/CPA in NR-DC [RAN3, RAN2]
CHO including target MCG and target SCG is used as the baseline

In RAN2 #119-e the following agreements were reached for this objective:
Observation: Current RAN2 Stage-3 specifications can support CHO including target MCG and target SCG in Rel-17.
CHO configuration referring to or including CPC/CPA configuration (intended to be applicable together) can be supported.
FFS: When triggering CHO, UE perform CPC/CPA configuration to start CPC/CPA evaluation, FFS if CHO evaluation and CPC/CPA evaluation is concurrent or sequential.

And in RAN2 #120 one more agreement was made:
Execution order: the UE doesn't execute CPC/CPA unless CHO condition is fulfilled (regardless parallel or sequential evaluation)

In this contribution different aspects and open issues related to objective 4 in the WID on rel-18 work on further NR mobility enhancements (0) are discussed.

### 2 Discussion

### 2.1 CHO Including Target MCG and Associated CPC or CPA

### 2.1.2 Sequential or Simultaneous Evaluation and Execution of CHO With Associated CPC/CPA

Sequential Evaluation and Execution of CHO with Associated CPC/CPA

In RAN2 #120 it was discussed whether the evaluation and execution of CHO and CPA/CPC should be done simultaneously or in sequence. One common aspect of the two solutions is that it is the CHO condition(s) that determine when the UE should perform the conditional reconfiguration execution. When the CHO condition(s) are fulfilled, the UE executes the CHO. If only the CPC/CPA condition(s) associated with the CHO are fulfilled, the UE doesn't execute CHO with associated CPC/CPA.

There are different pros and cons of the UE performing sequential or simultaneous evaluation and execution of CHO and CPC/CPA. If sequential evaluation of CHO and CPC/CPA is performed, the procedures will be more easily defined. The UE first applies a target configuration for CHO and then the UE starts evaluating the condition(s) for CPC/CPA which are then included in the applied target configuration for CHO. One drawback is that the execution of CPC/CPA may be delayed a bit, but that delay will in most cases not make any difference as it can be assumed that the mobility procedures in the source SCG are well-working and that the UE normally has the most suitable SCG. Also, even if RAN2 decides that the execution is sequential, the UE may by implementation perform simultaneous evaluation of the conditions for CHO and CPC/CPA, which would lead to very short delay of the execution of CPC/CPA after the execution of CHO.

In case of sequential evaluation and execution, the network needs to either provide a pure CHO configuration with associated CPA configurations for the SCG candidates or a CHO with SCG configuration and associated CPC configurations for other SCG candidates, or to the UE. In the latter case the SCG configuration is (likely) the current SCG, and where this configuration is applied by the UE when the CHO condition(s) are fulfilled. A possible drawback is then that this configuration may need to be updated when there are PSCell changes performed during the evaluation, before the CHO condition(s) are fulfilled.

Sequential evaluation and execution may lead to more reconfigurations, either if the CHO with SCG configuration is updated by the network after each PSCell change during the evaluation, or, if the network chooses not to update the CHO with SCG configuration, after the execution of CHO as likely a subsequent CPC/CPA will be executed in such case.

The procedures for defining and configuring sequential evaluation and execution of CHO and CPC/CPA are simpler.

In case of sequential evaluation and execution, the CHO with associated CPC or CPA configuration consists of either a CHO only (and CPA), or a CHO with SCG configuration (and CPC).

The UE may perform simultaneous evaluation of CHO and CPC/CPA, even if the executions are sequential.

There may be a delay in the execution of CPC/CPA in case of sequential execution, but the delay is likely not significant.

There may be more reconfiguration procedures in case of sequential execution.

Simultaneous Evaluation and Execution of CHO with Associated CPC/CPA

If simultaneous evaluation and execution of CHO and CPC/CPA is performed, the UE procedures will likely be more complex to define compared to the sequential evaluation/execution. If e.g. only the CHO condition(s) are fulfilled, but not the CPC/CPA conditions, the UE anyhow needs to execute the CHO in order not to impact the performance of the UE and the KPIs in the network. This could be achieved by the network providing a CHO with SCG configuration (and/or a pure CHO configuration) to the UE.

Another possibility is that the network provides a CPC configuration also for the current cell, but there is anyhow no guarantee that the CPC/CPA condition(s) are fulfilled when the CHO condition(s) are fulfilled, as the UE may have moved away from the current SCG and into the coverage of an SCG which is not configured as a CPC/CPA candidate. Therefore, some criteria for which target configuration the UE should select in case only the CHO condition(s) are fulfilled need to be described.

Another complexity with simultaneous execution is that the UE needs to perform simultaneous evaluation of execution condition(s) which belong to different measurement objects. For CHO, the UE needs to perform measurements related to source MN measConfig, but for the candidate SCG measurements configured by the target MN, i.e. CPA or MN-initiated CPC, the measurements would be related to the target MN measConfig.

A related problem is how the execution condition(s) could be defined. One possibility is to add an OCTET STRING containing the execution conditions of the target MCG in CondReconfigToAddMod. If the target MN execution conditions would be added as an OCTET STRING, some capability coordination between the network nodes would be needed, so that the UE capabilities related to the number of measurements would not be exceeded when multiple nodes define execution conditions which should be monitored simultaneously.

One possibility to decrease the complexity could be to merge the target MN and source MN measConfig in the network side, so that the UE only receives one MCG measConfig from the source MN, but where the target MN has defined execution conditions for the candidate SCG, i.e. CPA or MN-initiated CPC. Merging of source MN and target MN measConfig is possible, but it also requires coordination between the nodes.

One advantage of simultaneous monitoring and execution is that the execution of the CHO and CPC/CPC is likely faster. Another advantage is that the UE may select the most suitable PSCell directly without the need for reconfiguration of the CHO with SCG configuration at each PSCell change while still being in the source PCell.

With simultaneous evaluation and execution of CHO and CPC/CPA, UE actions for when only CHO conditions are fulfilled and when both CHO and CPC/CPA conditions are fulfilled need to be defined.

Depending on how CHO with associated CPC/CPA is signalled, the network may need to define one configuration for CHO only and one CHO with SCG target configuration per CPC/CPA configuration in case of simultaneous evaluation and execution. The definition of execution conditions may require capability coordination between the network nodes or possibly coordination of MCG measConfig.

The execution process of CHO and CPC is likely faster with simultaneous execution.

The UE will select the most suitable PSCell directly without the need for reconfiguration of the CHO with SCG configuration at each PSCell change while being in the source PCell.

RAN2 needs to discuss and agree on whether sequential or simultaneous evaluation and execution of CHO with candidate SCG should be specified. Both options are possible, but there are advantages and disadvantages with both solutions.

Discuss whether sequential or simultaneous evaluation of CHO with associated CPC/CPA should be specified.

### CONCLUSION

In the previous sections we made the following observations:

| | |
|---|---|
| Observation 1 | In rel-17, when CHO + CPC is configured, the CPC configurations are included in |
| | the source MN configuration. |
| Observation 2 | The procedures for defining and configuring sequential evaluation and execution |
| | of CHO and CPC/CPA are simpler. |
| Observation 3 | The network may need to define a CHO only or CHO with SCG target |
| | configuration in addition to the CHO with candidate SCG configuration with |
| | sequential execution. |
| Observation 4 | The UE may perform simultaneous evaluation of CHO and CPC/CPA, even if the |
| | executions are sequential. |
| Observation 5 | There may be a delay in the execution of CPC/CPA in case of sequential |
| | execution, but the delay is likely not significant. |
| Observation 6 | There may be more reconfiguration procedures in case of sequential execution. |
| Observation 7 | With simultaneous evaluation and execution of CHO and CPC/CPA, UE actions |
| | for when only CHO conditions are fulfilled and when both CHO and CPC/CPA |
| | conditions are fulfilled need to be defined. |
| Observation 8 | The network may need to define a CHO only or CHO with SCG target |
| | configuration in addition to the CHO with candidate SCG configuration also with |
| | simultaneous execution. |
| Observation 9 | The definition of execution conditions may require capability coordination |
| | between the network nodes orpossibly coordination of MCG measConfig. |
| Observation 10 | The execution process of CHO and CPC is likely faster with simultaneous |
| | execution. |
| Observation 11 | The UE will select the most suitable PSCell directly without the need for |
| | reconfiguration of the CHO with SCG configuration at each PSCell change while |
| | being in the source PCell. |

Based on the discussion in the previous sections we propose the following:

| | |
|---|---|
| Proposal 1 | The target candidate MN receives a Handover Request for CHO and triggers an |
| | MN-initiated SN Addition request towards the target candidate SN(s).. |
| Proposal 2 | Discuss whether sequential or simultaneous evaluation of CHO with candidate |
| | SCG should be specified. |

### REFERENCES

RP-221799, Revised WID on Further NR mobility enhancements, MediaTek Inc., 3GPP TSG RAN Meeting #96, Jun. 6-9, 2022

1-27. (canceled)

28. A method for handling a conditional reconfiguration execution, wherein the method is performed by a User Equipment (UE), the method comprising:
selecting a triggered Primary Cell (PCell) and an associated triggered Primary Secondary Cell (PSCell) for the conditional reconfiguration execution as a joint selection, wherein:
in response to a plurality of triggered PCells and an associated plurality of triggered PSCells existing, selecting one of the plurality of triggered PCells and an associated triggered PSCell for the conditional reconfiguration execution; and
in response to only one triggered PCell and associated triggered PSCell existing, selecting the one triggered PCell and the associated triggered PSCell for the conditional reconfiguration execution.

29. The method as claimed in claim 28, wherein a PCell configuration is stored for the selected triggered PCell, and wherein the method comprises applying the PCell configuration.

30. The method as claimed in claim 28, wherein a PSCell configuration is stored for the selected triggered PSCell, and wherein the method comprises applying the PSCell configuration.

31. The method as claimed in claim 28, further comprising receiving a message comprising first information indicative of at least one candidate PCell and at least one associated candidate PSCell, and wherein the selecting comprises selecting the triggered PCell and the associated triggered PSCell for the conditional reconfiguration execution in response to the at least one candidate PCell comprising at least one triggered PCell and the at least one associated candidate PSCell comprising at least one associated triggered PSCell.

32. The method as claimed in claim 31, wherein the message comprises second information indicative of a PCell configuration for the at least one candidate PCell and third information indicative of a PSCell configuration for the at least one candidate PSCell.

33. The method as claimed in claim 32, wherein:
the PCell configuration comprises a Conditional PSCell Change (CPC) configuration and the CPC configuration comprises the third information; or
an Information Element (IE) of the message comprises the second information and the third information.

34. The method as claimed in claim 31, wherein the message comprises fourth information indicative of a PCell execution condition for the at least one candidate PCell, and wherein the method comprises evaluating whether the PCell execution condition is fulfilled for the at least one candidate PCell.

35. The method as claimed in claim 34, wherein:
the at least one candidate PCell comprises a plurality of candidate PCells;
the fourth information is indicative of a PCell execution condition for each of the plurality of candidate PCells; and
evaluating whether the PCell execution condition is fulfilled comprises evaluating whether the PCell execution condition is fulfilled for each of the plurality of candidate PCells.

36. The method as claimed in claim 31, wherein:
the message comprises fifth information indicative of a PSCell execution condition for the at least one candidate PSCell; and
the method comprises evaluating whether the PSCell execution condition is fulfilled for the at least one candidate PSCell.

37. The method as claimed in claim 36, wherein:
the at least one candidate PSCell comprises a plurality of candidate PSCells;
the fifth information is indicative of a PSCell execution condition for each of the plurality of candidate PSCells; and
evaluating whether the PSCell execution condition is fulfilled comprises evaluating whether the PSCell execution condition is fulfilled for each of the plurality of candidate PSCells.

38. The method as claimed in claim 28, wherein the triggered PCell is a candidate PCell for which a PCell execution condition is fulfilled, and the associated triggered PSCell is a candidate PSCell for which a PSCell execution condition is fulfilled.

39. The method as claimed in claim 28, further comprising performing the conditional reconfiguration execution for the selected triggered PCell and associated triggered PSCell.

40. The method as claimed in claim 28, wherein the conditional reconfiguration execution is a conditional handover (CHO) execution.

41. A user equipment (UE) for handling a conditional reconfiguration execution, wherein the UE comprises processing circuitry configured to cause the UE to:
select a triggered Primary Cell (PCell) and an associated triggered Primary Secondary Cell (PSCell) for the conditional reconfiguration execution as a joint selection, such that:
in response to a plurality of triggered PCells and an associated plurality of triggered PSCells existing, the UE selects one of the plurality of triggered PCells and an associated triggered PSCell for the conditional reconfiguration execution; and
in response to only one triggered PCell and associated triggered PSCell existing, the UE selects the one triggered PCell and the associated triggered PSCell for the conditional reconfiguration execution.

42. The UE as claimed in claim 41, wherein a PCell configuration is stored for the selected triggered PCell, and wherein the processing circuitry is further configured to cause the UE to apply the PCell configuration.

43. The UE as claimed in claim 41, wherein a PSCell configuration is stored for the selected triggered PSCell, and wherein the processing circuitry is further configured to cause the UE to apply the PSCell configuration.

44. The UE as claimed in claim 41, further comprising receiving a message comprising first information indicative of at least one candidate PCell and at least one associated candidate PSCell, and wherein the selecting comprises selecting the triggered PCell and the associated triggered PSCell for the conditional reconfiguration execution in response to the at least one candidate PCell comprising at least one triggered PCell and the at least one associated candidate PSCell comprising at least one associated triggered PSCell.

45. The UE as claimed in claim 44, wherein the message comprises second information indicative of a PCell configuration for the at least one candidate PCell and third information indicative of a PSCell configuration for the at least one candidate PSCell.

46. The UE as claimed in claim 45, wherein:
the PCell configuration comprises a Conditional PSCell Change (CPC) configuration and the CPC configuration comprises the third information; or
an Information Element (IE) of the message comprises the second information and the third information.

47. The UE as claimed in claim 44, wherein the message comprises fourth information indicative of a PCell execution condition for the at least one candidate PCell, and wherein the method comprises evaluating whether the PCell execution condition is fulfilled for the at least one candidate PCell.

48. The UE as claimed in claim 47, wherein:
the at least one candidate PCell comprises a plurality of candidate PCells;
the fourth information is indicative of a PCell execution condition for each of the plurality of candidate PCells; and
evaluating whether the PCell execution condition is fulfilled comprises evaluating whether the PCell execution condition is fulfilled for each of the plurality of candidate PCells.

49. The UE as claimed in claim 44, wherein:
the message comprises fifth information indicative of a PSCell execution condition for the at least one candidate PSCell; and
the method comprises evaluating whether the PSCell execution condition is fulfilled for the at least one candidate PSCell.

50. The UE as claimed in claim 47, wherein:
the at least one candidate PSCell comprises a plurality of candidate PSCells;
the fifth information is indicative of a PSCell execution condition for each of the plurality of candidate PSCells; and
evaluating whether the PSCell execution condition is fulfilled comprises evaluating whether the PSCell execution condition is fulfilled for each of the plurality of candidate PSCells.

51. The UE as claimed in claim 41, wherein the triggered PCell is a candidate PCell for which a PCell execution condition is fulfilled, and the associated triggered PSCell is a candidate PSCell for which a PSCell execution condition is fulfilled.

52. The UE as claimed in claim 41, further comprising performing the conditional reconfiguration execution for the selected triggered PCell and associated triggered PSCell.

53. The UE as claimed in claim 41, wherein the conditional reconfiguration execution is a conditional handover (CHO) execution.
